(19) United States
(12) Patent Application Publication
(10) Pub. No.: US 2026/0231091 A1
(43) Pub. Date: Aug. 6, 2026

(54) COOPERATIVE ULTRA-WIDEBAND POSITIONING

(71) Applicant: QUALCOMM Incorporated, San Diego, CA (US)

(72) Inventors: Varun Amar REDDY, San Diego, CA (US); Alexandros MANOLAKOS, Athens (GR); Krishna Kiran MUKKAVILLI, San Diego, CA (US); Le Nguyen LUONG, San Diego, CA (US)

(21) Appl. No.: 19/151,249

(22) PCT Filed: Mar. 22, 2024
(86) PCT No.: PCT/US2024/021214

§ 371 Date: Jul. 25, 2025

(30) Foreign Application Priority Data
Mar. 29, 2023 (GR) 20230100265

(51) Int. Cl. H04W 64/00; H04W 8/22; H04W 24/10

(52) U.S. Cl. CPC H04W 64/00; H04W 8/22; H04W 24/10

(57) ABSTRACT

In an aspect, a first network entity may receive a first ranging control message indicating a set of second network entities that are part of a ranging session in which the first network entity is included. The first network entity may perform a first set of measurements for the ranging session. The first network entity may receive, from each second network entity of the set of second network entities, an indication of a respective second set of measurements for the ranging session. The first network entity may transmit an indication of an aggregated set of measurements based on the first set of measurements and each respective second set of measurements.

### CROSS-REFERENCE TO RELATED APPLICATION

This application claims the benefit of Greek patent application No. 20230100265, entitled “COOPERATIVE ULTRA-WIDEBAND POSITIONING” and filed on Mar. 29, 2023, which is expressly incorporated by reference herein in its entirety.

### TECHNICAL FIELD

The present disclosure relates generally to positioning systems, and more particularly, to positioning systems involving ultra-wideband (UWB) devices.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first network entity are provided. The apparatus may include memory and at least one processor coupled to the memory. The at least one processor, based at least in part on information stored in the memory may be configured to receive a first ranging control message indicating a set of second network entities that are part of a ranging session in which the first network entity is included, to perform a first set of measurements for the ranging session, to receive, from each second network entity of the set of second network entities, an indication of a respective second set of measurements for the ranging session, and to transmit an indication of an aggregated set of measurements based on the first set of measurements and each respective second set of measurements.

In another aspect of the disclosure, a method, a computer-readable medium, and an apparatus at a first network entity are provided. The apparatus may include memory and at least one processor coupled to the memory. The at least one processor, based at least in part on information stored in the memory may be configured to transmit, for a set of second network entities, a first ranging control message indicating the set of second network entities that are part of a first ranging session in which the first network entity is included, to transmit, for the set of second network entities, a first ranging initiation message, and to receive, from at least one second network entity of the set of second network entities, a first indication of an aggregated set of measurements based on the first ranging initiation message.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating a UWB system.

FIG. 6 is a diagram illustrating another UWB system.

FIG. 7A is a call flow diagram illustrating a method of wireless communication in accordance with various aspects of this present disclosure.

FIG. 7B is a call flow diagram illustrating a method of wireless communication in accordance with various aspects of this present disclosure.

FIG. 8 is a diagram illustrating a ranging block.

FIG. 9 is a call flow diagram illustrating a method of wireless communication in accordance with various aspects of this present disclosure.

FIG. 10 is a call flow diagram illustrating a method of wireless communication in accordance with various aspects of the present disclosure.

FIG. 11 is a call flow diagram illustrating a method of wireless communication in accordance with various aspects of the present disclosure.

FIG. 12 is a call flow diagram illustrating a method of wireless communication in accordance with various aspects of the present disclosure.

FIG. 13A is a call flow diagram illustrating a method of wireless communication in accordance with various aspects of the present disclosure.

FIG. 13B is a call flow diagram illustrating a method of wireless communication in accordance with various aspects of the present disclosure.

FIG. 14 is a flowchart illustrating methods of wireless communication in accordance with various aspects of the present disclosure.

FIG. 15 is a flowchart illustrating methods of wireless communication in accordance with various aspects of the present disclosure.

FIG. 16 is a flowchart illustrating methods of wireless communication in accordance with various aspects of the present disclosure.

FIG. 17 is a flowchart illustrating methods of wireless communication in accordance with various aspects of the present disclosure.

FIG. 18 is a diagram illustrating an example of a hardware implementation for an example apparatus and/or network entity.

FIG. 19 is a diagram illustrating an example of a hardware implementation for an example network entity.

### DETAILED DESCRIPTION

Various aspects relate generally to positioning systems. Some aspects more specifically relate to cooperative UWB ranging sessions. In some examples, a UWB initiator may configure a ranging session between the UWB initiator and a plurality of UWB responders. The UWB initiator may transmit a ranging initiation message to each of the UWB responders. In response, each of the UWB responders may transmit a ranging response message to the UWB initiator and to each of the other UWB responders. Each of the UWB responders may perform timing and/or angle measurements based on the ranging initiation message and/or the ranging response messages received thereby. Each of the UWB responders may aggregate the measurements performed thereby, along with the measurements performed by the other UWB responders (which may be received via the ranging response messages). Each of the UWB responders may generate a measurement report that includes the aggregated measurements and may provide the measurement report to the UWB initiator and/or each of the UWB responders. The UWB device (e.g., the UWB initiator or the UWB responders) that receive the measurement reports may determine a range estimate for itself and/or any of the other UWB devices that provided the measurement reports.

Particular aspects of the subject matter described in this disclosure can be implemented to realize one or more of the following potential advantages. In some examples, by cooperatively performing and sharing measurements between a plurality of UWB devices, the time of arrival estimation quality is improved, which in turn, enables a more accurate range estimate for a particular device, as there are additional points of reference with respect to the device for which the range estimate is determined.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

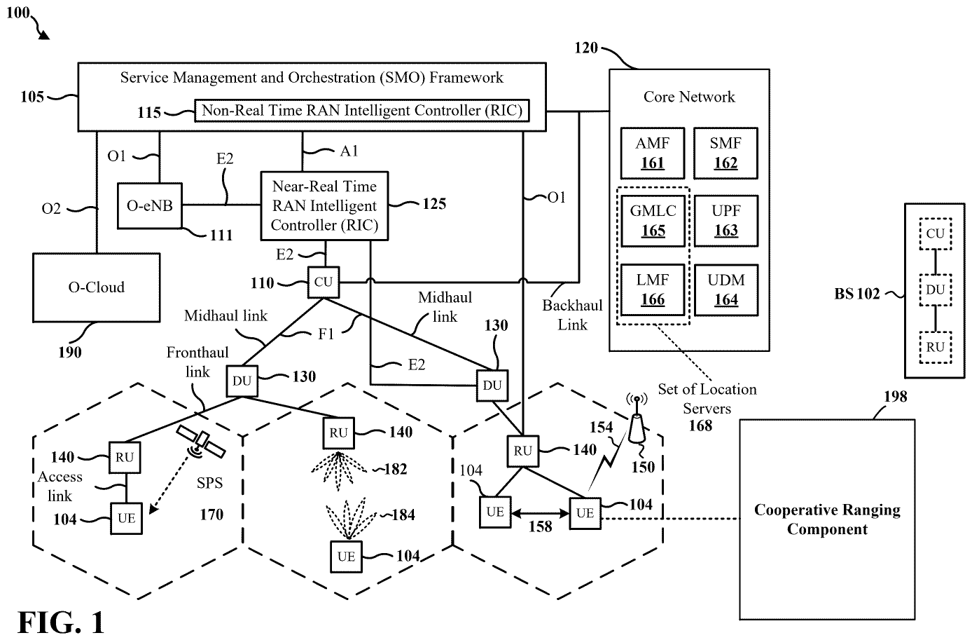

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a cooperative ranging component 198 that may be configured to receive a first ranging control message indicating a set of second network entities that are part of a ranging session in which the first network entity is included, to perform a first set of measurements for the ranging session, to receive, from each second network entity of the set of second network entities, an indication of a respective second set of measurements for the ranging session, and to transmit an indication of an aggregated set of measurements based on the first set of measurements and each respective second set of measurements. In certain aspects, the cooperative ranging component 198 may be configured to transmit, for a set of second network entities, a first ranging control message indicating the set of second network entities that are part of a first ranging session in which the first network entity is included, to transmit, for the set of second network entities, a first ranging initiation message, and to receive, from at least one second network entity of the set of second network entities, a first indication of an aggregated set of measurements based on the first ranging initiation message.

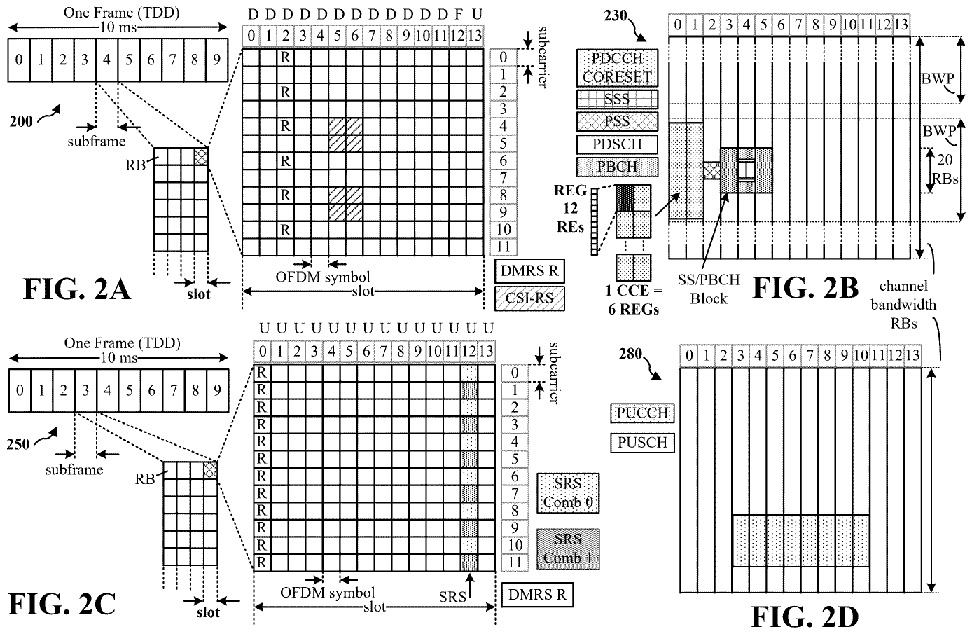

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 24*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

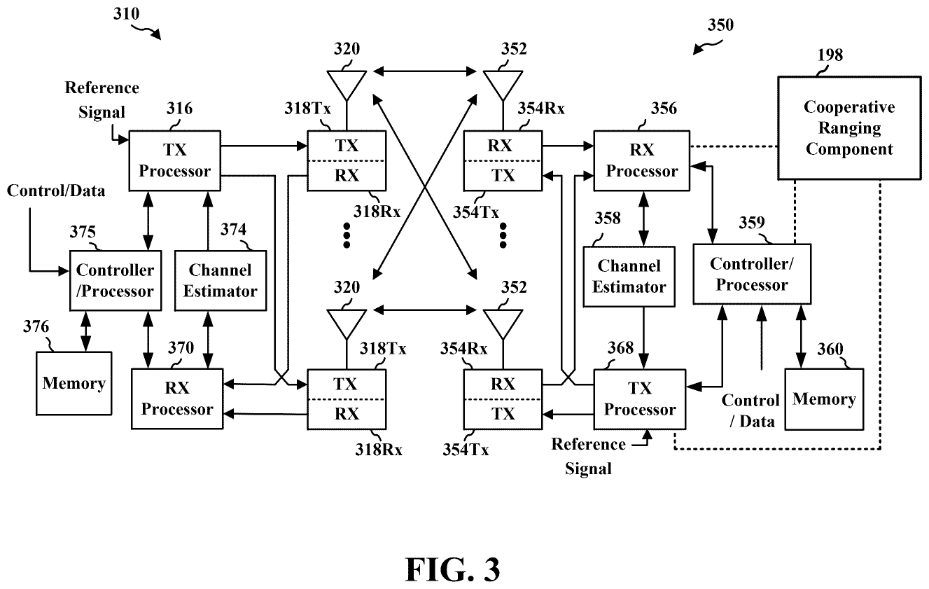

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the cooperative ranging component 198 of FIG. 1.

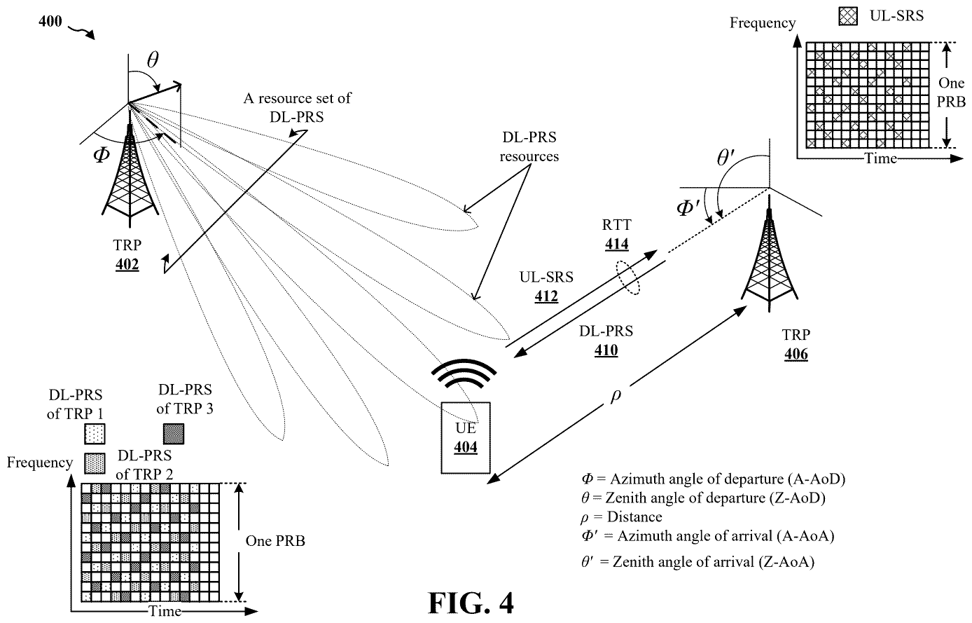

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

In addition to network-based UE positioning technologies, a wireless device (e.g., a UE, an access point (AP), etc.) may also be configured to include sensing capabilities, where the wireless device may be able to sense (e.g., detect and/or track) one or more objects or target entities of an area or in an environment based on radio frequencies. An environment may refer to a particular geographical area or place, especially as affected by human activity, or the circumstances, objects, or conditions by which one is surrounded. For example, a wireless device may include a radar capability (which may be referred to as “RF sensing” and/or “cellular-based RF sensing), where the wireless device may transmit reference signals (e.g., radar reference signals (RRSs)) and measure the reference signals reflected from one or more objects (e.g., structures, walls, living objects, and/or things in an environment, etc.). Based on the measurement, the wireless device may determine or estimate a distance between the wireless device and the one or more objects and/or obtain environmental information associated with its surrounding. In another example, a first wireless device may receive signals transmitted from a second wireless device, where the first wireless device may determine or estimate a distance between the first wireless device and the second wireless device based on the received signals. For example, a tracking device (e.g., a Bluetooth tracker, an item tracker, an asset tracking device, etc.) may be configured to regularly transmit signals (e.g., beacon signals) or small amounts of data to a receiving device, such that the receiving device may be able to monitor the location or the relative distance of the tracking device. As such, a user may be able to track the location of an item (e.g., a car key, a wallet, a remote control, etc.) by attaching the tracking device to the item. For purposes of the present disclosure, a device/apparatus that is capable of performing sensing (e.g., transmitting and/or receiving signals for detecting at least one object or for estimating the distance between the device and the at least one object) may be referred to as a “sensing device,” a “sensing node,” or a “sensing entity.” For example, a sensing device may be a UE, an AP device (e.g., a Wi-Fi router), a base station, a component of the base station, a TRP, a device capable of performing radar functions, etc. Furthermore, a target entity may be any object (e.g., a person, a vehicle, a UE, etc.) for which a positioning or sensing session is performed, for example, to determine a location thereof, a velocity thereof, a heading thereof, a physiological characteristic thereof, etc. In addition, a device/apparatus that is capable of transmitting signals to a sensing device for the sensing device to determine the location or the relative distance of the device/apparatus may be referred to as a “tracking device,” a “tracker,” or a “tag.”

For purposes of the present disclosure, a positioning session may be referred to the transmitting, the receiving, and the measuring of reference signals for the purposes of determining a positioning result or state (e.g., a location, a heading, a velocity, etc.) of a target entity. An RF sensing session may be referred to the transmitting, the receiving, and the measuring of reference signals for the purposes of determining a sensing result or state of an environment in which the target entity is included (e.g., a change in the environment), at least one physiological characteristic of a target entity, a location of the target entity, a velocity of the target entity, a heading of the target entity, etc.

Ultra-wideband, or UWB, is a short-range RF technology for wireless communication that can be leveraged to detect the location of people, devices, and assets with great precision. Like other communication protocols, such as Bluetooth™ and Wi-Fi, UWB may be used to transmit data between devices through radio waves, for example, using short nanosecond pulses over an ultra-wide range of frequencies (e.g., 3.1 GHz to 10.6 GHz). UWB technology may utilize billions of pulses of radio that are sent every couple of nanoseconds as a pattern across a wide frequency spectrum (e.g., at least 500 MHz or 20% of the center frequency). These signals may be dispatched from a transmitter to a receiver, or amongst transceivers. The receiving device may analyze the incoming pattern and translate it into data. While this allows devices to quickly send data over short ranges, these UWB signals can also be used to accurately sense the location of devices. This makes it possible for UWB-enabled devices (like smart phones, sensors, or anchors (e.g., electronic devices that detect UWB pulses emitted by UWB tags and forward them to a location server (e.g., the location server(s) 168) for calculating tag positions)) to pinpoint a transmitting device, such as another smart phone or asset tracking tag, find its precise location, and in certain applications enable location-aware communication and services.

Examples of UWB devices include, but are not limited to, a smart phone, a laptop, a PDA, a tablet, a smart device, a wearable device (e.g., a virtual reality/augmented reality headset, a smart watch, etc.), a vehicle, an electric meter, a gas pump, a large or small kitchen appliance, a healthcare device, an implant, a sensor/actuator, a display, a tracking device, a tag, an IoT device, or any other similar functioning device that is configured to transmit and/or receive data utilizing UWB technology.

UWB devices in the same vicinity may exchange measurements with each other to perform cooperative positioning or cooperative sensing, which in turn help the devices to improve their positioning estimates cooperatively. The cooperative positioning may be relative and may be performed in conjunction with absolute positioning measurements (e.g., NR-based measurements, GNSS-based measurements, etc.).

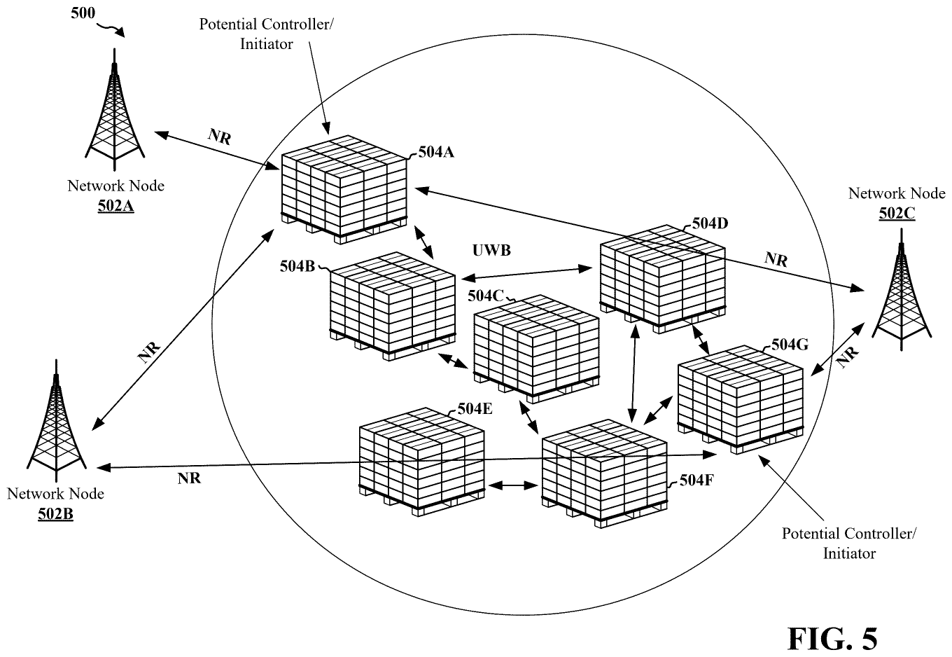

For example, FIG. 5 is a diagram 500 illustrating a UWB system. As shown in FIG. 5, a plurality of UWB devices (e.g., tags) may be coupled to a plurality of packages/pallets 504A, 504B, 504C, 504C, 504D, 504E, 504F, and 504G, for example, inside a warehouse/retail store. A subset of the plurality of UWB devices may have cellular connectivity. For instance, the UWB devices coupled to packages/pallets 504A and 504G may have cellular connectivity, thereby enabling such UWB devices to communicate with one or more of network nodes (e.g., the network node 502A, the network node 502B, and the network node 502C) via NR-based transmissions. As further shown in FIG. 5, each of the UWB devices may be communicatively coupled with one or more other UWB devices via UWB transmissions.

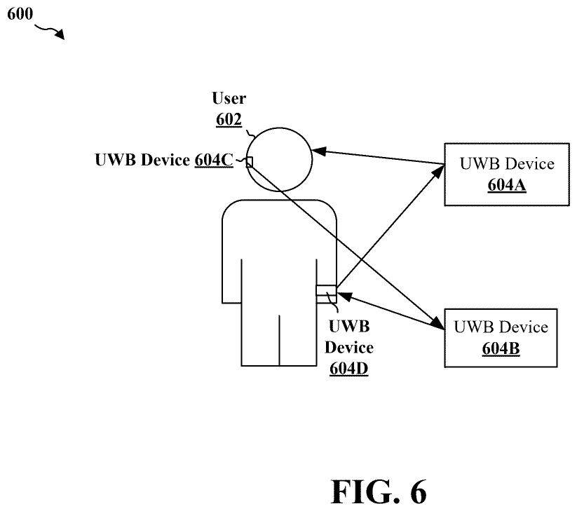

FIG. 6 is a diagram 600 illustrating another UWB system. As shown in FIG. 6, one or more UWB devices (e.g., UWB device 604A and 604B) may be located proximate to a user 602, and UWB device(s) (e.g., UWB device 604C and 604D) may be located on the body of the user 602. UWB device(s) 604A-604D may exchange wireless signals with each other to generate a virtual map of the environment in which the user 602 is located and/or determine a sensing result or state of the environment in which the user 602 is included (e.g., a change in the environment), at least one physiological characteristic of the user 602, a location of the user 602, a velocity of the user 602, a heading of the user 602, etc.

Certain UWB devices may include enhanced security (e.g., using a 128-bit scrambled timestamp sequence (STS) key) and improved positioning accuracy for high rate pulses (HRPs). Such devices may be referred to as enhanced ranging devices (ERDEVs). An ERDEV may have different roles. For instance, one role may be a controller, which controls the ranging and defines the ranging parameters by sending a ranging control message (RCM). An RCM may be a frame that is transmitted at the beginning of a ranging round. The RCM may convey an advanced ranging control information element (ARC IE) and may be used to set the ranging parameters controlling one or more ranging procedures. The RCM may configure various aspects of the ranging procedure(s), such as the time-slot structure, the ranging methods, and STS packet configuration. The RCM may also indicate a set of UWB devices that are to be part of a ranging session and may indicate a ranging slot index that is assigned for each UWB device in the set. Another role may be a controlee, which utilizes the ranging parameters received from the controller in the RCM to perform ranging operations. That is, the RCM provides the ranging configuration to the controlee and sets up a ranging session. For purposes of the present disclosure, a ranging session may be referred to the transmitting, the receiving, and the measuring of ranging signals for the purposes of determining a range (e.g., a position or location) estimate of a device, an angle of arrival of the ranging signals, etc. A ranging session may also be utilized to convey data, which may be included as a payload in a ranging signal of the ranging session.

Once the ranging session is set up, the controller and controlee may take on a new role, such as an initiator or a responder. An initiator, following the reception of the RCM, may be configured to initiate a ranging exchange by sending the first message (or ranging frame (RFRAME)) of the exchange, which may be referred to as the ranging initiation message (RIM). The RIM may include a device identifier of the device that transmits the RIM and/or various timing information. For example, the timing information may include a time and/or angle at which the RIM was transmitted. Either a controller or a controlee may be an initiator. A responder may be configured to respond to the RIM received from the initiator with a ranging response message (RRM) (also referred to as a beacon). The RRM may include a device identifier of the device that transmits the RRM and/or various timing information. For example, the timing information may include a time between receiving the RIM and transmitting the RRM, the time and/or angle the RIM was received, the time and/or angle the RRM was sent, etc. The RIM and RRM may be UWB-based transmissions, whereas the RCM may be either UWB-based transmissions or out-of-band (OOB) transmissions, such as Bluetooth™-based transmissions, Wi-Fi-based transmissions, etc. The RIM and RRM may be utilized to calculate the distance between the initiator and the responder and/or the location or position of the initiator and/or the responder.

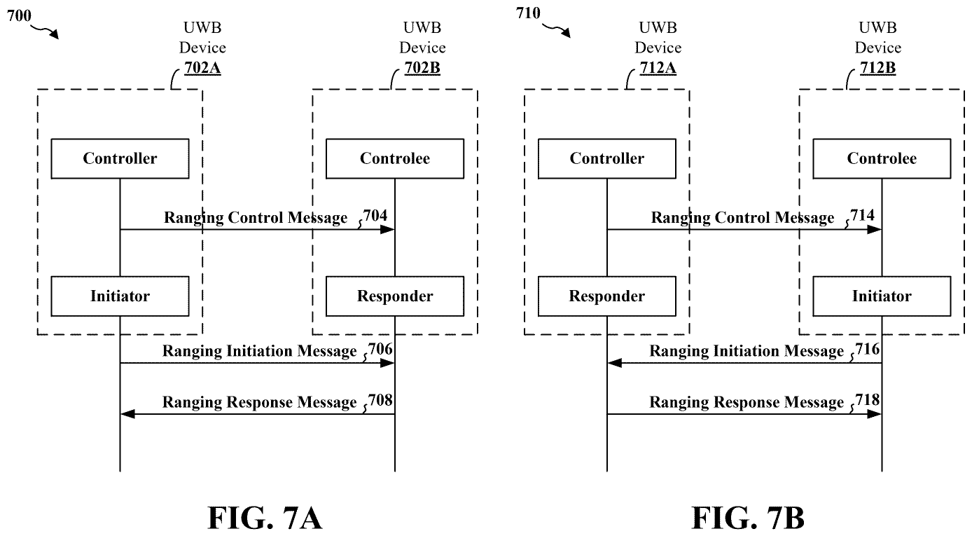

For example, FIGS. 7A and 7B are call flow diagrams 700 and 710 illustrating a method of wireless communication in accordance with various aspects of the present disclosure. In particular, the diagram 700 of FIG. 7A illustrates a UWB device 702A configured as a controller and an initiator and a UWB device 702B configured as a controlee and a responder. The diagram 710 of FIG. 7B illustrates a UWB device 712A configured as a controller and a responder and a UWB device 712B configured as a controlee and an initiator. As shown in FIG. 7A, at 704, the UWB device 702A (acting as a controller) may provide an RCM to the UWB device 702B (acting as a controlee). At 706, the UWB device 702A (also acting as an initiator) may provide an RIM to the UWB device 702B (also acting as a responder). In response to receiving the RIM, the UWB device 702B, at 708, may provide an RRM to the UWB device 702A. As shown in FIG. 7B, at 714, the UWB device 712A (acting as a controller) may provide an RCM to the UWB device 702B (acting as a controlee). At 716, the UWB device 702B (also acting as an initiator) may provide an RIM to the UWB device 702A (also acting as a responder). In response to receiving the RIM, the UWB device 702A, at 718, may provide an RRM to the UWB device 702B.

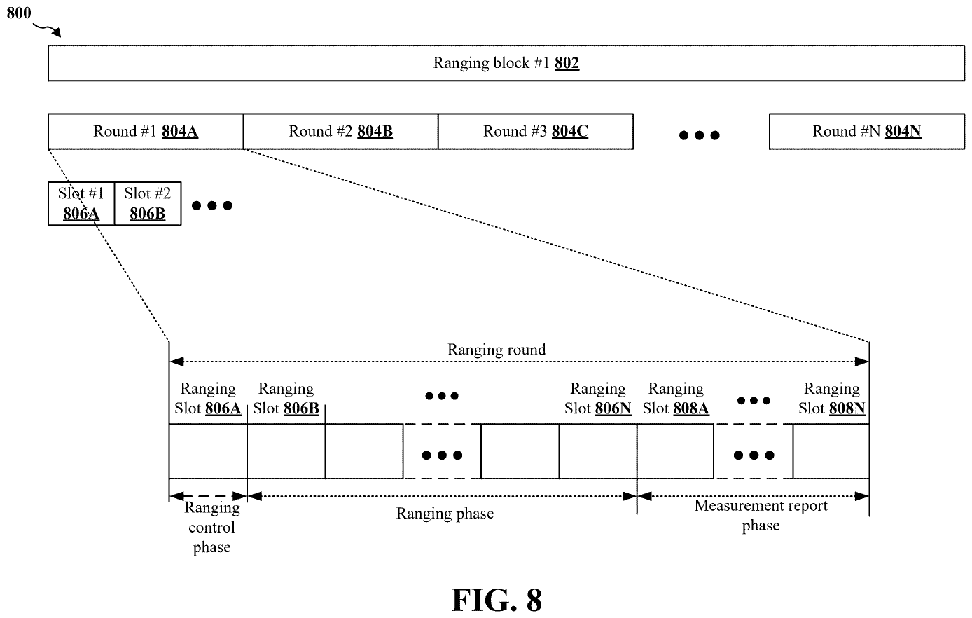

A UWB ranging session between two devices may include consecutive ranging blocks. Each block may have a particular first duration, for example, 200 milliseconds. Each block may include one or more ranging rounds, which in turn has several ranging slots. Each slot may have a particular second duration, for example, 1 millisecond. Each round may include a single slot for the control phase, followed by the ranging and measurement report phases. After the ranging phase, ERDEVs may be scheduled in the measurement report phase to send the requested information (such as RTT, AoA measurements, etc.). This information may be sent as a data packet between the initiator and a given responder. For example, FIG. 8 is a diagram 800 illustrating a ranging block 802. As shown in FIG. 8, the ranging block 802 may include a plurality of ranging rounds 804A, 804B, 804C, . . . , 804N (804A-804N). Each of the ranging rounds 804A-804N may include a plurality of ranging slots (e.g., the ranging slots 806A, 806B, . . . , 806N (806A-806N). The ranging slot 806A may be utilized for the ranging control phase (in which an RCM is transmitted from a controller to a controlee), the ranging slots 806B-806N may be utilized for a ranging phase (in which one or more RIMs and RRMs are exchanged between an initiator and a responder), and the ranging slots 808A, . . . , 808N (808A-808N) may be utilized for a measurement report phase in which measurements (e.g., time of arrival measurements, AoA measurements, etc.) obtained at a responder based on the RIM(s) and RRM(s) are reported back to the initiator. The initiator may perform calculations to determine the range of the initiator and/or the responder.

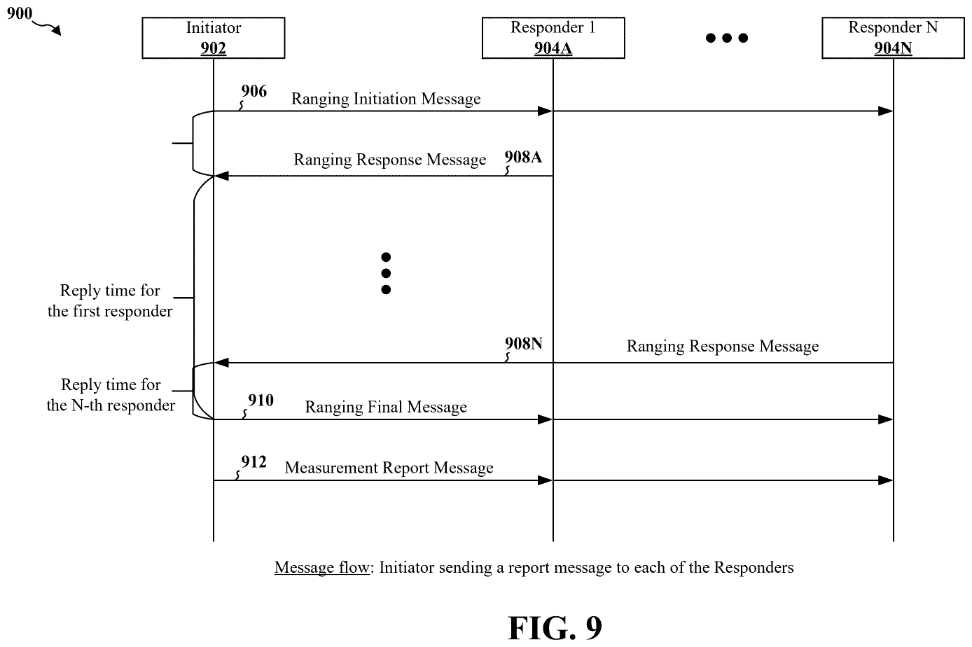

Current implementations enable the reporting of measurements between the initiator and a given responder. For example, the initiator and an Nth responder may just exchange RTT and/or AoA measurements that were recorded using the packets exchanged between the initiator and the Nth responder, where N is any positive integer. For instance, FIG. 9 is a call flow diagram 900 illustrating a method of wireless communication in accordance with various aspects of the present disclosure. As shown in FIG. 9, at 906, a first UWB device (e.g., an initiator 902) may provide an RIM to each of a second UWB device (responder 904A) and an Nth UWB device (responder 904N). At 908A, the initiator 902 may receive an RRM from the responder 904A in a particular ranging slot in the ranging phase and may determine the RTT for the responder 904A based on a first time at which the RIM was transmitted at 906 and a second time at which the RRM was received from the responder 904A at 908A. At 908N, the initiator 902 may receive an RRM from the responder 904N from a particular ranging slot in the ranging phase and may determine the RTT for the responder 904N based on a first time at which the RIM was transmitted at 906 and a second time at which the RRM was received from the responder 904N at 908N.

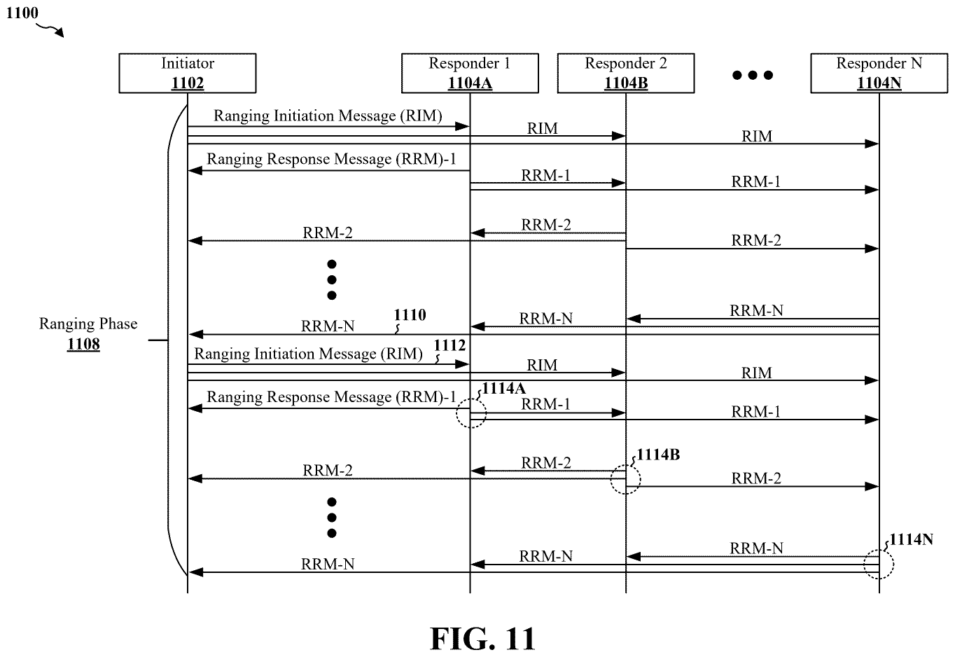

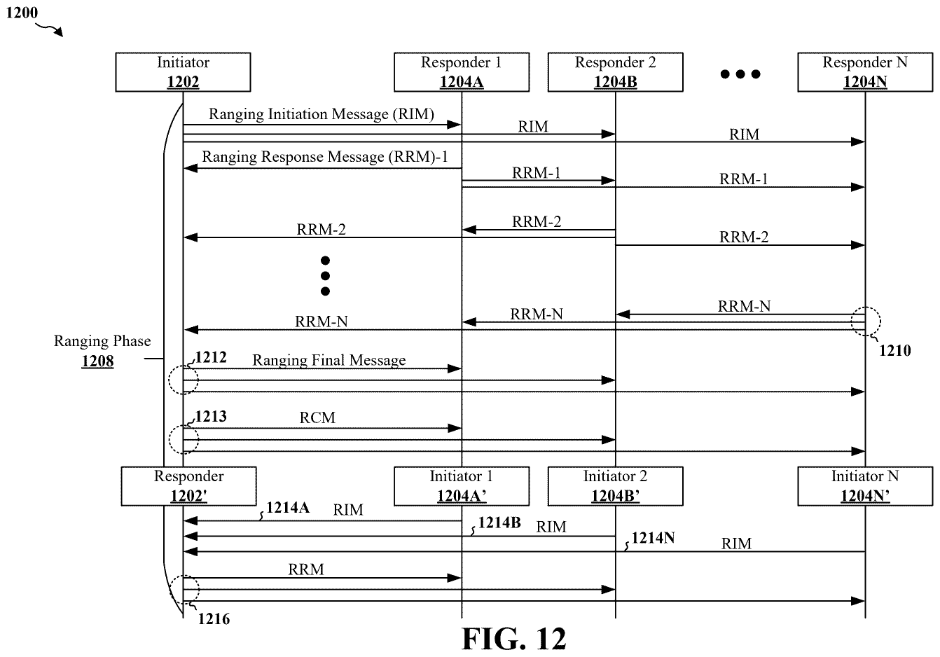

At 910, the initiator 902 may transmit a ranging final message (RFM) to each of the responders 904A-904N to enable double-sided ranging, which mitigates ranging calculation errors due to clock drift between the initiator 902 and the responders 904A-904N. In time of arrival estimation, there are some calculation errors that can arise from the clock synchronization error between the initiator 902 and the responders 904A-904N. Each of the initiator 902 and the responders 904A-904N has its own clock, which are generally not identical in practice. Because of this, when the devices determine an estimate, they are not synchronized with each other (e.g., the clock of the initiator 902 may run slower than the clock of the responders 904A-904N by one nanosecond). This offset may introduce biases in the range estimates. To mitigate this, a third message (e.g., the RFM) may be exchanged between the initiator 902 and each of the responders 904A-904N, which reduces the impact of the clock offset. Additional details regarding double-sided ranging are described below with reference to FIGS. 11 and 12.

At 912, the initiator 902 may transmit a measurement report message to each of the responders 904A-904N. The measurement report message may include the measurement(s) determined by the initiator 902 (e.g., the RTT measurement) and/or the measurements determined by the responder(s) 904A-904N that may be provided via the RRM(s) 908A-908N. For instance, in the example shown in FIG. 9, each RRM may include measurements obtained by its associated responder. The measurement report message may include all the measurements obtained by all the responders 904A-904N, along with any measurements obtained by the initiator 902.

In accordance with various aspects of the present disclosure, to enable cooperative positioning, UWB devices may be enabled to provide measurements obtained from signals pertaining to other UWB devices (i.e., devices other than the initiator, such as other responders) in their respective vicinities (rather than just between the initiator and a particular responder). That is, each the devices (i.e., the initiator 902 and the responders 904A-904N) utilize the measurements obtained from all the other devices. It is noted that while the aspects described herein describe ranging techniques for positioning sessions, the aspects described herein are also applicable for sensing sessions.

A UWB controller/initiator may be a more capable device in terms of measurements it can make, its computational complexity (e.g., it may include more advanced hardware (e.g., a chipset)) an amount of memory or storage supported thereby, or battery resources (e.g., it may include a relatively longer-lasting battery). For instance, the controller/initiator may be capable of estimating its own coarse position (e.g., using NR-based measurements, GNSS-based measurements, Wi-Fi-based measurements, etc.). Referring again to FIG. 5, the UWB devices coupled to the packages/pallets 504A and 504G may be UWB controller/initiators, as they are communicatively coupled to both a non-UWB network and a UWB-network, and therefore, may be capable of estimating its own coarse position via non-UWB-based transmissions. In some aspects, the RCM transmitted by an initiator may include a list of devices in the vicinity (which are also part of the same UWB session). The initiator may determine such devices utilizing a discovery mechanism in which the initiator detects and measures beacons transmitted by such devices with respect to a particular responder. The ranging slot indexes corresponding to each of the responder transmissions may also be included in the RCM. That is, the RCM may indicate the ranging slot index assigned for each responder. Each of the responders may listen to the channel in the slot(s) identified by the ranging slot index(es) (i.e., in the slot(s) assigned thereto) and perform measurements. An aggregate measurement report may then be provided by each of the responders to either the initiator or broadcasted to all the responders during the measurement report phase. Each aggregate measurement report may include the measurements from all the responders. For example, if the initiator is configured to determine a range estimate for one or more UWB devices, each of the responders may provide an aggregate measurement report to the initiator. In another example, in which a distributed approach in which each responder may be configured to determine its own range estimate, each of the responders may broadcast its aggregate measurement report to all the other responders.

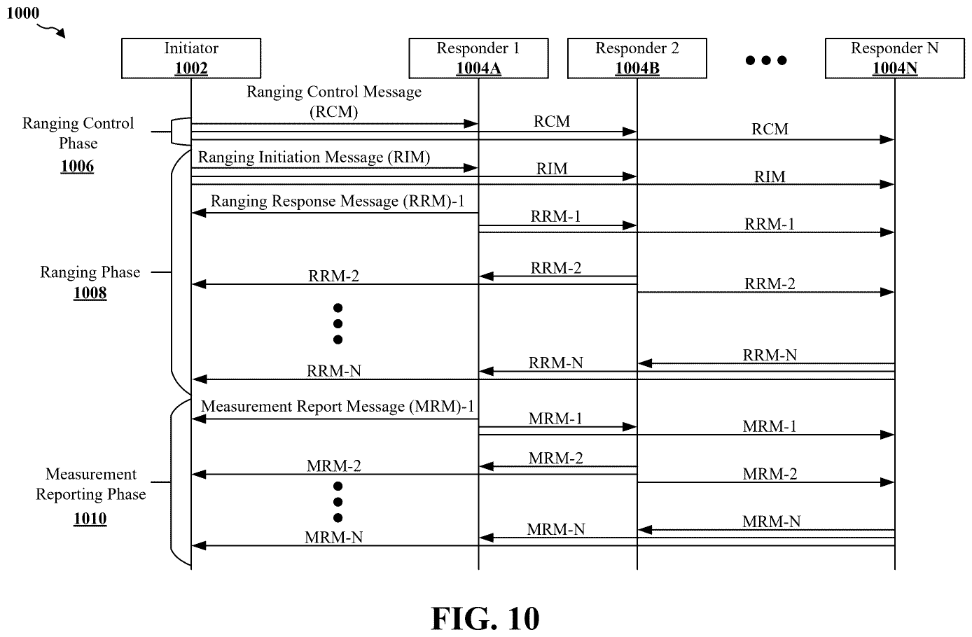

FIG. 10 is a call flow diagram 1000 illustrating a method of wireless communication in accordance with various aspects of the present disclosure. In particular, the diagram 1000 illustrates cooperative report messaging. As shown in FIG. 10, during a ranging control phase 1006, an initiator 1002 may transmit (e.g., broadcast) an RCM to each of the responders 1004A-1004N. The RCM may be transmitted via a UWB-based network or via an OOB network, such as Bluetooth™, Wi-Fi, etc.

During a ranging phase 1008, the initiator 1002 may transmit (e.g., broadcast) an RIM to each of the responders 1004A-1004N. Each responder of the responders 1004A-1004N may transmit an RRM to the initiator 1002 and/or the other responders of the responders 1004A-1004N. For instance, in an aspect in which there are three responders, the responder 1004A may transmit an RRM to the initiator 1002 and/or each of the responders 1004B and 1004N. The responder 1004B may transmit an RRM to the initiator 1002 and/or each of the responders 1004A and 1004N. The responder 1004N may transmit an RRM to the initiator 1002 and/or each of the responders 1004A and 1004B. Each responder of the responders 1004A-1004N may be configured to detect the RIM and/or RRM in the ranging slot index(es) assigned thereto. The initiator 1002 and/or each of the responders 1004A-1004N may be configured to perform a set of measurements based on the RIM and/or the RRMs received thereby. For example, each of the responders 1004A-1004N may be configured to determine a time of flight of the RIM based on a first time at which the RIM was transmitted by the initiator 1002 and a second time at which the RIM was received. The first time may be indicated in the RIM. The time of flight may be equal to the difference between the first time and the second time. In another example, the initiator 1002 may be configured to determine a respective round-trip time for each of the responders 1004A-1004N based on a first time at which the RIM is transmitted therefrom and a respective second time at which each RRM is received thereby. The round-trip time may be equal to the difference between the first time and the second time.

During a measurement reporting phase 1010, each responder of the responders 1004A-1004N may be configured to generate an aggregated measurement report. The aggregated measurement report may include the timing information included in each of the RRMs received thereby and/or the RIM received thereby. The aggregated measurement report of a particular responder may also include the set of measurements performed by the responder with respect to each of the RIM and/or RRMs received thereby. Each responder of the responders 1004A-1004N may provide the aggregated measurement report to the initiator 1002 and/or the other responders of the responders 1004A-1004N via a measurement report message (MRM). That is, the MRM transmitted by a particular responder may include the aggregated measurement report generated thereby. In one aspect, each of the responders 1004A-1004N may be configured to unicast an MRM to the initiator 1002. That is, each of the responders 1004A-1004N may transmit an MRM to just the initiator 1002. In another aspect, each responder of the responders 1004A-1004N may broadcast an MRM to the initiator 1002 and/or the other responders of the responders 1004A-1004N. For instance, in an aspect in which there are three responders, the responder 1004A may transmit an MRM to the initiator 1002 and/or each of the responders 1004B and 1004N. The responder 1004B may transmit an MRM to the initiator 1002 and/or each of the responders 1004A and 1004N. The responder 1004N may transmit an MRM to the initiator 1002 and/or each of the responders 1004A and 1004B. In a further aspect, each of the responders 1004A-1004N may be configured to transmit a MRM to a location server (e.g., location server(s) 168) or an LMF (e.g., the LMF 166). The initiator 1002 and/or each of the responders 1004A-1004N may be configured to determine a range estimate for the initiator 1002 and/or one or more of the responders 1004A-1004N based on the aggregated measurement reports respectively received thereby.

In the aspects described above with reference to FIG. 10, single-sided two-way ranging may be utilized to mitigate ranging calculation errors due to clock drift. In certain aspects, the impact of clock drift between devices may be reduced through double-sided two-way ranging, where an additional third message may be sent by a transmitting device (after the exchange of two messages between the transmitting device and the receiving device). Utilizing these messages, a set of time periods (e.g., the round-trip time and the time it takes for a responder to reply (i.e., send an RRM)) may be utilized to calculate the distance between two devices (e.g., an initiator and a responder or two responders) instead of using timestamps. This is because the period of a certain time is the same for each device regardless of their own clock references. However, because of the imperfections of clock oscillators in the real world, a clock drifts over time. These clock drifts cause inaccuracy in measuring the time periods described above. For example, a 1 nanosecond error in the time of flight may lead to an approximate error of 30 centimeters in range estimation. Such errors are mitigated using double-sided two-way ranging.

Double-sided two-way ranging may be implemented in various ways. For example, in a first approach, during the ranging phase, after the last RRM (e.g., RRM-N) is transmitted, all the devices (e.g., the initiator 1002 and the responders 1004A-1004N) may transmit an additional ranging message. For example, the initiator 1002 may transmit another RIM, and each of the responders 1004A-1004N may transmit another RRM. For example, FIG. 11 is a call flow diagram 1100 illustrating a method of wireless communication in which double-sided two-way ranging is utilized in accordance with the first approach. As shown in FIG. 11, during a ranging phase 1108, after the last RRM-N is transmitted at 1110, the initiator 1102 may transmit a second RIM at 1112 to each of the responders 1104A-1104N. As also shown in FIG. 11, at, 1114A, 1114B, and 1114N, each of the responders 1104A-1104N may, respectively, optionally transmit a second set of RRMs to the initiator 1102 and the other responders of responders 1104A-1104N. Utilizing the messages described above, a first round-trip time (t_{roundA}) between the initiator 1102 and each of the responders 1104A-1104N may be determined (e.g., based on the difference between the time at which the RIM is transmitted and a time at which a respective RRM is received), a reply time (t_{replyB}) of each of the responders 1104A-1104N may be determined (e.g., based on the difference in time between when a respective responder receives an RIM and transmits an RRM), a second round-trip time (t_{roundB}) between the initiator 1102 and each of the responders 1104A-1104N may be determined (e.g., based on the difference between the time at which the initiator 1102 receives a respective RRM and transmits the second RIM at 1112), and a reply time (t_{replyA}) of the initiator 1102 may be determined (e.g., based on the difference in time between when the initiator 1102 receives a respective RRM and transmits the second RIM at 1112). The initiator 1102 may determine a time of flight between itself and a respective responder of the responders 1104A-1104N based on these values. For instance, the time of flight between the initiator 1102 and a respective responder of the responders 1104A-1104N may be determined as follows:

$$time of flight = \frac{1}{4} ( ( {t}_{round A} - {t}_{replyA} ) + ( ( {t}_{roundB} - {t}_{replyB} ) ) \qquad Eq . 1$$

In a second approach, during the ranging phase, after the last RRM (e.g., RRM-N) is transmitted, the initiator 1102 may transmit an additional ranging message. The initiator 1102 (i.e., the controller) may also schedule one-way ranging sessions that originate from all the other devices (that is, the responders 1104A-1104N in the earlier session now become initiators). For example, FIG. 12 is a call flow diagram 1200 illustrating a method of wireless communication in which double-sided two-way ranging is utilized in accordance with the second approach. As shown in FIG. 12, after receiving the last RRM at 1210 in the ranging phase 1208, the initiator 1202 may send an extra ranging message at 1212 to each of the responders 1204A, 1204B, . . . , 1204N (1204A-1204N). The extra ranging message may be a ranging final message. The initiator 1202 may also configure each of the responders 1204A-1204N to be initiators (shown as the initiators 1204A′-1204N′), for example, by providing each of the responders 1204A-1204N with an RCM at 1213 that configures each of the responders 1204A-1204N accordingly. The initiator 1202 may also re-configure itself to be a responder 1202′. After re-configuring the responders 1204A-1204N to be initiators 1204A′-1204N′ and re-configuring the initiator 1202 to be a responder 1202′, each of the initiators 1204A′-1204N′ may provide a respective ranging message at 1214A, 1214B, and 1214N to the responder 1202′. Each of the ranging messages may be an RIM. The responder 1202′ may optionally transmit an RRM at 1216 to each of the initiators 1204A′-1204N′. Each of the responders 1204A-1204N may perform a set of measurements based on the RIM transmitted thereby and/or the RRM received thereby. The responder 1202′ may perform a set of measurements based on the ranging message transmitted at 1212, the ranging messages received at 1214A, 1214B, and 1214N, and/or the RRMs transmitted at 1216.

Using either approach described above would complete the exchange of at least three messages between any given pair of devices, which in turn reduces the error associated with clock drift. The above two approaches may be extended to a case where more than three messages are exchanged between any two of the devices.

In some aspects, adaptive scheduling over different ranging rounds may be implemented, where a different set of responders may be utilized for different ranging rounds. For example, a ranging control update message (RCUM) may be transmitted by the controller at the last slot of a ranging round specified by the RCM. The RCUM may include ranging parameters to be utilized by the controlees in a subsequent ranging round. That is, the controlees may update their respective ranging parameters utilizing the parameters included in the RCUM. For example, the RCUM may be used to modify and indicate, for each of the responders, a subset of other devices (e.g., responders) in the vicinity (and/or that are available for a ranging session) for whose measurements are to be recorded during the ranging phase. The RCUM may also modify and indicate the set of slot indexes corresponding to the subset of the other devices.

For a given responder, the subset of other devices may be determined by the controller (or a remote server (e.g., location server(s) 168 or the LMF (e.g., the LMF 166 thereof)), which in turn, may provide assistance data to the controller. For a given responder device, some decision criteria for determining the subset of other devices may include, but is not limited to, a quality of the received signal from a particular device (e.g., the signal strength (e.g., based on a received signal strength indicator (RSSI)), the signal-to interference and noise ratio (SINR), the carrier-to-noise ratio (CIR), etc.), a number of other devices or neighboring nodes (with respect to the current device), a geometry of the other devices with respect to the current device (e.g., the range and angle of the other devices with respect to the current device), a confidence metric of the position metric (e.g., a level of uncertainty of the other devices with respect to their own position estimate), the remaining power/battery resources of the other devices (e.g., a device may choose to not take part in the next round to conserve power using block striding), whether the other devices have connectivity to another technology or communication protocol (e.g., NR, Wi-Fi, GNSS, etc.), whether the other devices themselves may need a higher position estimate accuracy (which in turn may need the current responder to exchange ranging messages), etc.

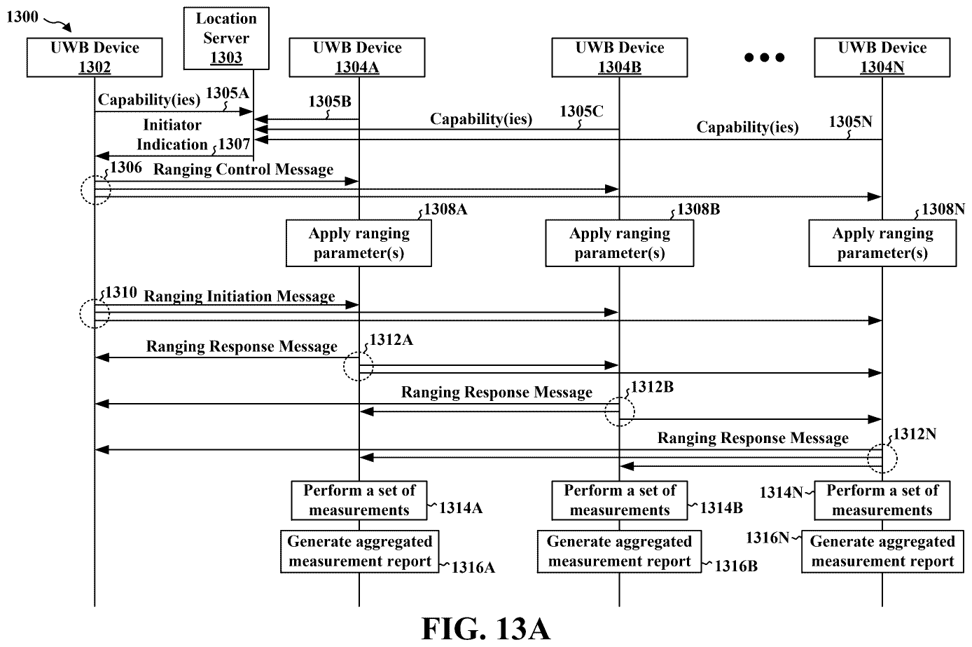

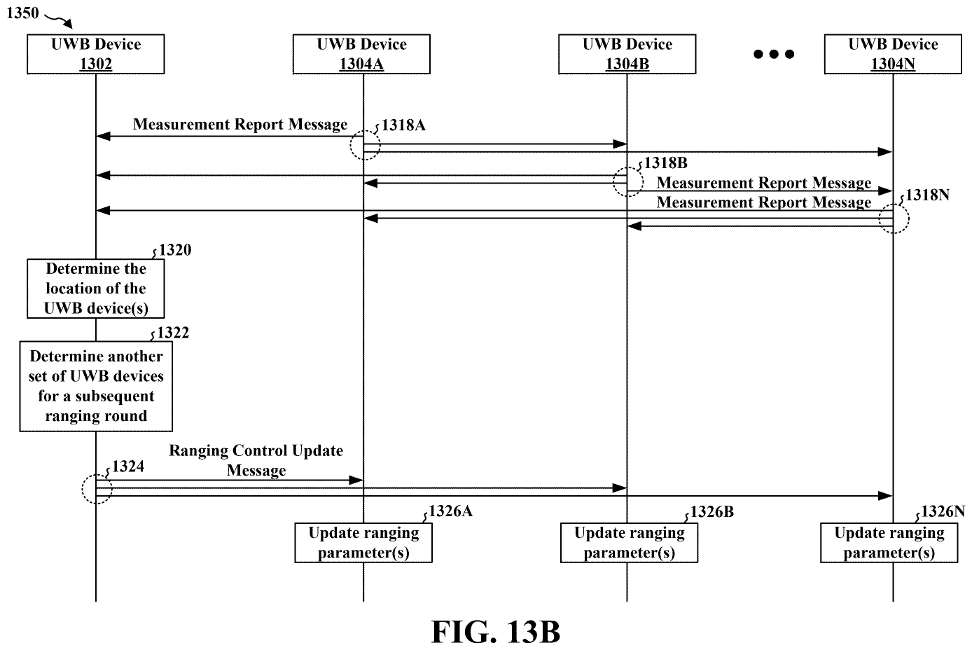

FIGS. 13A and 13B are call flow diagrams 1300 and 1350 illustrating a method of wireless communication in accordance with various aspects of the present disclosure. As shown in FIGS. 13A and 13B, the diagrams 1300 and 1350 include a first UWB device 1302, a second UWB device 1304A, a third UWB device 1304B, an Nth UWB device 1304N, and a location server 1303. Each of the first UWB device 1302, the second UWB device 1304A, the third UWB device 1304B, and the Nth UWB device 1304N may be an example of the UE 104, the UE 350, the UE 404, the UWB device 604A, the UWB device 604B, the UWB device 604C, the UWB device 702A, the UWB device 702B, the UWB device 712A, the UWB device 712B, the initiator 902, the responders 904A-904N, the initiator 1002, the responders 1004A-1004N, the initiator 1102, the responders 1104A-1104N, the initiator 1202, and the responders 1204A-1204N. The location server 1303 may be an example of the location server(s) 168. As shown in FIG. 13A, the first UWB device 1302 may be initially configured as an initiator, and each of the second UWB device 1304A, the third UWB device 1304B, and the Nth UWB device 1304N may be initially configured as responders.

As shown in FIG. 13A, at 1305A, 1305B, 1305C, and 1305N, the first UWB device 1302, the second UWB device 1304A, the third UWB device 1304B, and/or the Nth UWB device 1304N may respectively provide an indication of one or more capabilities thereof. In the example shown in FIG. 13A, the indications may be provided to a network entity, such as the location server 1303 and/or an LMF (e.g., the LMF 166) maintained thereby.

The location server 1303 and/or the LMF may determine which of the UWB devices is to be the initiator that initiates a ranging session (e.g., a UWB ranging session) based on the capability(ies) of the first UWB device 1302, the second UWB device 1304A, the third UWB device 1304B, and the Nth UWB device 1304N.

In some aspects, the capability(ies) may include a capability that enables a particular UWB device to determine its own location via a communication session (e.g., a Wi-Fi-based communication session, a GNSS-based communication session, an NR-based communication session) other than the UWB ranging session. The capability(ies) may also include a capability based on a level of computational complexity supported by the particular UWB device. For instance, such a capability may indicate a level of computation complexity supported by the particular UWB device, where the computational complexity includes a particular chipset supported by the particular UWB device, a particular size and/or type of memory or storage supported by the particular UWB, etc. The capability(ies) may also include a capability based on one or more battery resources supported by the particular UWB device. For instance, such a capability may indicate a level of battery performance and/or longevity of the battery resource(s) supported by the particular UWB device. The location server 1303 and/or the LMF may select a UWB device that supports such a capability, as such a UWB device is more capable in terms of the measurements it can make. In the example shown in FIG. 13A, the location server 1303 and/or the LMF may determine that the first UWB device 1302 supports such a capability and selects the first UWB device 1302 as being the initiator. As shown in FIG. 13A, the location server 1303 and/or the LMF, at 1307, may provide an indication to the first UWB device 1302 that indicates that the first UWB device 1302 has been selected to be the initiator of the ranging session. In response to receiving the indication, the first UWB device 1302 may configure itself to be the initiator.

In another example, another network entity, such as a UWB device may determine which of the UWB devices is to be the initiator of the ranging session based on the capability(ies) of the UWB devices. For instance, each UWB device may provide its respective capabilities to the other UWB devices. For instance, the first UWB device 1302 may provide its capability(ies) to the second UWB device 1304A, the third UWB device 1304B, and the Nth UWB device 1304N. The second UWB device 1304A may provide its capability(ies) to the first UWB device 1302, the third UWB device 1304B, and the Nth UWB device 1304N. The third UWB device 1304B may provide its capability(ies) to the first UWB device 1302, the second UWB device 1304A, and the Nth UWB device 1304N. The Nth UWB device 1304N may provide its capability(ies) to the first UWB device 1302, the second UWB device 1304A, and the third UWB device 1304B. Each of such UWB devices (or an application executing thereon) may determine which of the other UWB devices supports the capability(ies) suitable for initiating a ranging session. The UWB device determined to be the initiator may be provided an indication from one or more of the other UWB devices that indicates that the UWB device has been selected to be the initiator. In response to receiving the indication, the UWB device may configure itself to be an initiator. As shown in FIG. 13A, at 1306, the first UWB device 1302 may transmit an RCM to each of the second UWB device 1304A, the third UWB device 1304B, and the Nth UWB device 1304N. The RCM may convey an ARC IE and may be used to set the ranging parameters controlling ranging procedure(s). The RCM may configure various aspects of the ranging procedure(s), such as the time-slot structure, the ranging methods, and STS packet configuration. The RCM may also indicate a set of UWB devices that are to be part of a ranging session (e.g., the first UWB device 1302, the second UWB device 1304A, the third UWB device 1304B, and/or the Nth UWB device 1304N) and may indicate a ranging slot index that is assigned for each UWB device in the set.

At 1308A, 1308B, and 1308N, the second UWB device 1304A, the third UWB device 1304B, and the Nth UWB device may apply the ranging parameters included in the RCM received at 1306. For instance, using the ranging parameters, each of the second UWB device 1304A, the third UWB device 1304B, and/or the Nth UWB device 1304N may determine which ranging slot index(es) are to be utilized for detecting various transmissions (e.g., RRMs) from other UWB devices.

At 1310, the first UWB device 1302 may transmit an RIM to each of the second UWB device 1304A, the third UWB device 1304B, and the Nth UWB device 1304N. The RIM may include a device identifier of the first UWB device 1302 and/or various timing information. For example, the timing information may include a time and/or angle at which the RIM was transmitted.

At 1312A, the second UWB device 1304A may transmit an RRM to each of the first UWB device 1302, the third UWB device 1304B, and the Nth UWB device 1304N. Each of the first UWB device 1302, the third UWB device 1304B, and the Nth UWB device 1304N may detect the RRM in the ranging slot index respectively assigned thereto. The RRM may include a device identifier of the second UWB device 1304A and/or various timing information. For example, the timing information may include a time between receiving the RIM and transmitting the RRM, the time and/or angle the RIM was received, the time and/or angle the RRM was sent, etc. For instance, after receiving the RIM at 1310, the second UWB device 1304A may perform a set of measurements to determine the time between receiving the RIM and transmitting the RRM, the time and/or angle the RIM was received, the time and/or angle the RRM was sent, etc.

At 1312B, the third UWB device 1304B may transmit an RRM to each of the first UWB device 1302, the second UWB device 1304A, and the Nth UWB device 1304N. Each of the first UWB device 1302, the second UWB device 1304A, and the Nth UWB device 1304N may detect the RRM in the ranging slot index respectively assigned thereto. The RRM may include a device identifier of the third UWB device 1304B and/or various timing information. For example, the timing information may include a time between receiving the RIM and transmitting the RRM, the time and/or angle the RIM was received, the time and/or angle the RRM was sent, etc. For instance, after receiving the RIM at 1310, the third UWB device 1304B may perform a set of measurements to determine the time between receiving the RIM and transmitting the RRM, the time and/or angle the RIM was received, the time and/or angle the RRM was sent, etc.

At 1312N, the Nth UWB device 1304N may transmit an RRM to each of the first UWB device 1302, the second UWB device 1304A, and the third UWB device 1304B. Each of the first UWB device 1302, the second UWB device 1304A, and the third UWB device 1304B may detect the RRM in the ranging slot index respectively assigned thereto. The RRM may include a device identifier of the Nth UWB device 1304N and/or various timing information. For example, the timing information may include a time between receiving the RIM and transmitting the RRM, the time and/or angle the RIM was received, the time and/or angle the RRM was sent, etc. For instance, after receiving the RIM at 1310, the Nth UWB device 1304N may perform a set of measurements to determine the time between receiving the RIM and transmitting the RRM, the time and/or angle the RIM was received, the time and/or angle the RRM was sent, etc.

At 1314A, the second UWB device 1304A may perform a set of measurements based on the RIM received at 1310 and/or the RRMs received at 1312B and 1312N. At 1314B, the third UWB device 1304B may perform a set of measurements based on the RIM received at 1310 and/or the RRMs received at 1312A and 1312N. At 1314N, the Nth UWB device 1304N may perform a set of measurements based on the RIM received at 1310 and/or the RRMs received at 1312A and 1312B. For example, each of the second UWB device 1304A, the third UWB device 1304B, and the Nth UWB device 1304N may be configured to determine a time of flight of the RIM based on a first time at which the RIM was transmitted by the first UWB device 1302 and a second time at which the RIM was respectively received, a time of arrival of the RIM based on the second time, an angle of arrival of the RIM, etc.

At 1316A, the second UWB device 1304A may generate an aggregated measurement report. The aggregated measurement report may include the timing information included in each of the RRMs received thereby and/or the RIM received thereby. The aggregated measurement report may also include the set of measurements performed by the second UWB device 1304A with respect to each of the RIM and/or RRMs received thereby.

At 1316B, the third UWB device 1304B may generate an aggregated measurement report. The aggregated measurement report may include the timing information included in each of the RRMs received thereby and/or the RIM received thereby. The aggregated measurement report may also include the set of measurements performed by the third UWB device 1304B with respect to each of the RIM and/or RRMs received thereby.

At 1316N, the Nth UWB device 1304N may generate an aggregated measurement report. The aggregated measurement report may include the timing information included in each of the RRMs received thereby and/or the RIM received thereby. The aggregated measurement report may also include the set of measurements performed by the Nth UWB device 1304N with respect to each of the RIM and/or RRMs received thereby.

As shown in FIG. 13B, at 1318A, the second UWB device 1304A may transmit a measurement report message including the aggregated measurement report to the first UWB device 1302 and/or each of the third UWB device 1304B and the Nth UWB device 1304N. At 1318B, the third UWB device 1304B may transmit a measurement report message including the aggregated measurement report to the first UWB device 1302 and/or each of the second UWB device 1304A and the Nth UWB device 1304N.

At 1318N, the Nth UWB device 1304N may transmit a measurement report message including the aggregated measurement report to the first UWB device 1302 and/or each of the second UWB device 1304A and the third UWB device 1304B.

In some aspects, each of the second UWB device 1304A, the third UWB device 1304B, and the Nth UWB device 1304N may transmit the measurement report message to a location server (e.g., location server(s) 168) and/or an LMF (e.g., the LMF 166).

At 1320, the first UWB device 1302 may determine a location (e.g., a range estimate) of one or more of the first UWB device 1302, the second UWB device 1304A, the third UWB device 1304B, and/or the Nth UWB device 1304N based on one or more of the aggregated measurement reports received via the measurement report messages received at 1318A, 1318B and/or 1318N. It is noted that one or more of the second UWB device 1304A, third UWB device 1304B, and/or the Nth UWB device 1304N may determine a range estimate for one or more of the first UWB device 1302, the second UWB device 1304A, the third UWB device 1304B, and/or the Nth UWB device 1304N based on one or more of the aggregated measurement reports received via the measurement report messages respectively received thereby.

At 1322, the first UWB device 1302 may determine another set of UWB devices to be utilized for a subsequent ranging round. For instance, the first UWB device 1302 may determine the another set based on at least one of a respective signal quality of a respective RRM received from each of the second UWB device 1304A, the third UWB device 1304B, and/or the Nth UWB device 1304N, a number of the UWB devices available (e.g., the second UWB device 1304A, the third UWB device 1304B, the Nth UWB device 1304N and/or other devices that have become in vicinity with the first UWB device 1302) for the subsequent ranging round, a respective geometry of the available UWB devices (e.g., range and/or angle with respect to the first UWB device 1302), a respective confidence metric of a position estimate of each of the second UWB device 1304A, the third UWB device 1304B, and/or the Nth UWB device 1304N (e.g., a level of uncertainty of the each of the second UWB device 1304A, the third UWB device 1304B, and/or the Nth UWB device 1304N with respect to their respective position estimate), a respective power level of each of each of the second UWB device 1304A, the third UWB device 1304B, and/or the Nth UWB device 1304N, a communication protocol supported by each of the second UWB device 1304A, the third UWB device 1304B, and/or the Nth UWB device 1304N, or an indication of a particular level of position estimate accuracy supported by each of the second UWB device 1304A, the third UWB device 1304B, and/or the Nth UWB device 1304N.

At 1324, the first UWB device 1302 may transmit an RCUM to each of the second UWB device 1304A, the third UWB device 1304B, and the Nth UWB device 1304N. The RCUM may be transmitted in the last ranging slot index of the ranging session. The last ranging slot index may be specified in the RIM transmitted at 1310. The RCUM may include at least one of an identification of another set of UWB devices (which may include a subset of the second UWB device 1304A, the third UWB device 1304B, and the Nth UWB device 1304N) for which another set of measurements are to be performed. The RCUM may also include a set of ranging slot indexes corresponding to the other set of UWB devices. That is, the RCUM may indicate the respective ranging slot index(es) that are assigned to each UWB device in the other set of UWB devices.

At 1326A, 1326B, and 1326N, the second UWB device 1304A, the third UWB device 1304B, and the Nth UWB device may update their respective ranging parameters included in the RCUM received at 1324. For instance, each of the second UWB device 1304A, the third UWB device 1304B, and/or the Nth UWB device may determine which ranging slot index(es) are to be utilized for detecting various transmissions (e.g., RRMs) from other UWB devices.

In some aspects, double-sided two-ranging may be utilized. For example, after 1312N, the first UWB device 1302 may transmit another RIM to each of the second UWB device 1304A, the third UWB device 1304B, and the Nth UWB device 1304N. In response, the second UWB device 1304A may transmit another RRM to the first UWB device 1302, the third UWB device 1304B, and the Nth UWB device 1304N, the third UWB device 1304B may transmit another RRM to the first UWB device 1302, the second UWB device 1304A, and the Nth UWB device 1304N, and the Nth UWB device 1304N may transmit another RRM to the first UWB device 1302, the second UWB device 1304A, and the third UWB device 1304B. The foregoing is depicted in FIG. 11, where the initiator 1102, at 1112, transmits an RIM to each of the responders 1104A-1104N, and each of the responders 1104A-1104N transmits, at 1114A, 1114B, and 1114N, respectively) an RRM to the initiator 1102 and the other responders of the responders 1104A-1104N.

Each of the first UWB device 1302, the second UWB device 1304A, the third UWB device 1304B, and the Nth UWB device 1304N may detect the other RRM in the respective ranging slot index assigned thereto. Each of the first UWB device 1302, second UWB device 1304A, the third UWB device 1304B, and the Nth UWB device 1304N may perform a set of measurements based on the other RIM and/or other RRMs received thereby.

In another example, after 1312N, the first UWB device 1302 may transmit another RCM to each of the second UWB device 1304A, the third UWB device 1304B, and the Nth UWB device 1304N. The other RCM may include parameter(s), that when implemented by the second UWB device 1304A, the third UWB device 1304B, and the Nth UWB device 1304N cause each of the second UWB device 1304A, the third UWB device 1304B, and the Nth UWB device 1304N to initiate another ranging session. In the other ranging session, each of the second UWB device 1304A, the third UWB device 1304B, and the Nth UWB device 1304N may be configured as initiators and the first UWB device 1302 is configured as a responder. Each of the second UWB device 1304A, the third UWB device 1304B, and the Nth UWB device 1304N may transmit an RIM to the first UWB device 1302. In response, the first UWB device 1302 may transmit an RRM to each of the second UWB device 1304A, the third UWB device 1304B, and the Nth UWB device 1304N. Each of the second UWB device 1304A, the third UWB device 1304B, and the Nth UWB device 1304N may perform a set of measurements based on the RIM transmitted thereby and/or the RRM received thereby. The foregoing is depicted in FIG. 12, where each of the initiators 1204A′-1204N′ may transmit an RIM at 1214A, 1214B, and 1214N respectively, and the responder 1202′, at 1216, may transmit an RRM to each of the initiators 1204A′-1204N′.

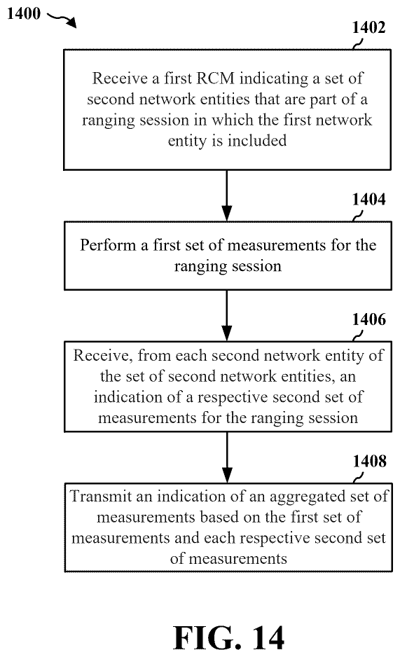

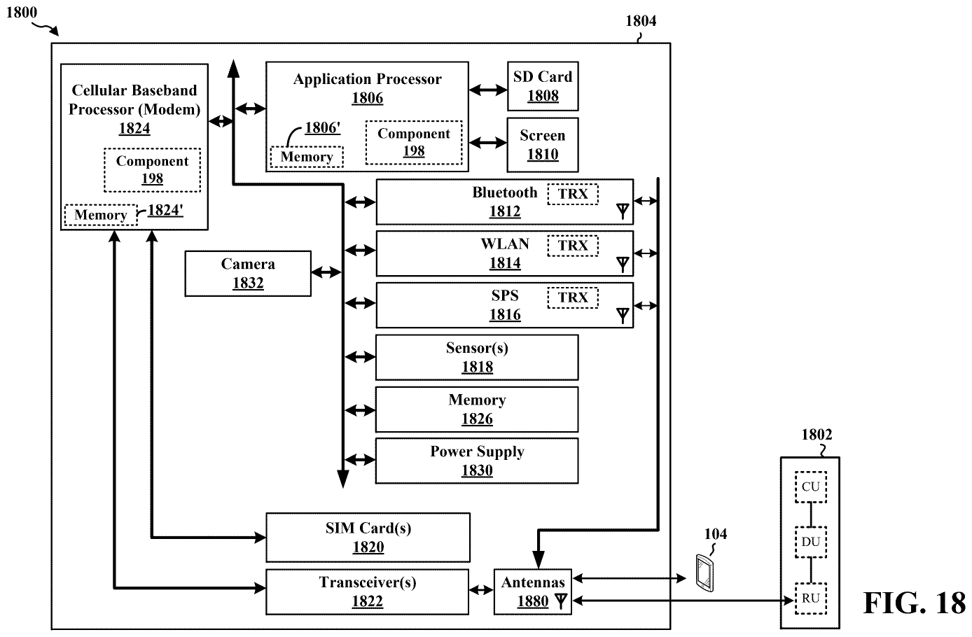

FIG. 14 is a flowchart 1400 illustrating methods of wireless communication at a first network entity in accordance with various aspects of the present disclosure. In some aspects, the first network entity may be the UE 104, the UE 350, the UE 404, the UWB device 604A, the UWB device 604B, the UWB device 604C, the UWB device 702A, the UWB device 702B, the UWB device 712A, the UWB device 712B, the responders 904A-904N, the responders 1004A-1004N, the responders 1104A-1104N, the responders 1204A-1204N, the UWB devices 1304A-1304N or the apparatus 1804 in the hardware implementation of FIG. 18. In the aspects described below, the first network entity may be described with reference to the second UWB device 1304A for the sake of brevity. However, it is noted that the first network entity may be any of UWB devices 1304A-1304N.

At 1402, the first network entity may receive a first RCM indicating a set of second network entities that are part of a ranging session in which the first network entity is included. For example, referring to FIG. 13A, at 1306, the second UWB device 1304A may receive an RCM from the first UWB device 1302. The RCM may indicate that the first UWB device 1302 and/or each of the second UWB device 1304A, the third UWB device 1304B, and/or the Nth UWB device 1304N are part of the ranging session. In an aspect, 1402 may be performed by the cooperative ranging component 198.

In some aspects, the first RCM may further indicate a ranging slot index for the first network entity. For example, referring to FIG. 13A, the RCM received at 1306 may further indicate a ranging slot index for the second UWB device 1304A.

At 1404, the first network entity may perform a first set of measurements for the ranging session. For example, referring to FIG. 13A, the second UWB device 1304A may perform a first set of measurements for the ranging session. In an aspect, 1404 may be performed by the cooperative ranging component 198.

In some aspects, the first network entity may perform the first set of measurements for the ranging session by detecting, in the ranging slot index, a first RRM from each second network entity of the set of second network entities, and performing the first set of measurements based on the first RRM from each second network entity of the set of second network entities. For example, referring to FIG. 13A, at 1312B, the second UWB device 1304A may detect the RRM from the third UWB device 1304B and, at 1312N, may detect the RRM from the Nth UWB device 1304N. At 1314A, the second UWB device 1304A may perform the first set of measurements for the ranging session based on the RRMs from the third UWB device 1304B and the Nth UWB device 1304N.

At 1406, the first network entity may receive, from each second network entity of the set of second network entities, an indication of a respective second set of measurements for the ranging session. For example, referring to FIG. 13A, at 1312B and 1312N, the second UWB device 1304A may receive, from the third UWB device 1304B and the Nth UWB device 1304N, an indication of a respective second set of measurements for the ranging session. The indication may be the RRMs received at 1312B and 1312N, respectively. For instance, the RRM received at 1312B may include timing information that includes a time between receiving the RIM at the third UWB device 1304B and transmitting the RRM from the third UWB device 1304B, the time and/or angle the RIM was received at the third UWB device 1304B, the time and/or angle the RRM was sent from the third UWB device 1304B, etc. The RRM received at 1312N may include timing information that includes a time between receiving the RIM at the Nth UWB device 1304N and transmitting the RRM from the Nth UWB device 1304N, the time and/or angle the RIM was received at the Nth UWB device 1304N, the time and/or angle the RRM was sent from the Nth UWB device 1304N, etc. In an aspect, 1406 may be performed by the cooperative ranging component 198.

At 1408, the first network entity may transmit an indication of an aggregated set of measurements based on the first set of measurements and each respective set of measurements. For example, referring to FIG. 13B, at 1318A, the second UWB device 1304A may transmit an indication (e.g., an MRM) of the aggregated set of measurements (e.g., the aggregated measurement report generated at 1316A) based on the first set of measurements performed at 1314A and the respective sets of measurements received at 1312B and 1312N. In an aspect, 1408 may be performed by the cooperative ranging component 198.

In some aspects, the first network entity may transmit the indication of the aggregated set of measurements by transmitting the indication of the aggregated set of measurements to each second network entity of the set of second network entities. For example, referring to FIG. 13B, at 1318A, the second UWB device 1304A may transmit the MRM by transmitting the MRM to each of the third UWB device 1304B and the Nth UWB device 1304N.

In some aspects, the first network entity may receive the first RCM by receiving the first RCM from a third network entity, and the first network entity may transmit the indication of the aggregated set of measurements by transmitting the indication of the aggregated set of measurements to the third network entity. For example, referring to FIG. 13A, at 1306, the second UWB device 1304A may receive the first RCM from the first UWB device 1302. Referring to FIG. 13B, at 1318A, the second UWB device 1304A may transmit the MRM by transmitting the MRM to the first UWB device 1302.

In some aspects, the first network entity may transmit the indication of the aggregated set of measurements by transmitting the indication of the aggregated set of measurements to at least one of a location server or an LMF. For example, referring to FIG. 13B, at 1318A, the second UWB device 1304A may transmit the MRM by transmitting the MRM to the at least one of the location server(s) 168 or the LMF 166.

In some aspects, the first network entity may receive an RCUM in a last ranging slot index of the ranging session, where the last ranging slot index is specified in the first RCM. The first network entity may update at least one ranging parameter based on the RCUM. For example, referring to FIG. 13B, at 1324, the second UWB device 1304A may receive an RCUM from the first UWB device 1302 in a last ranging slot index of the ranging session. The last ranging slot index may be specified in the RCM received at 1306. At 1326A, the second UWB device 1304A may update at least one ranging parameter based on the RCUM.

In some aspects, the at least one ranging parameter may include at least one of an identification of a set of third network entities for which a second set of measurements are to be performed or a set of ranging slot indexes corresponding to the set of third network entities. For example, referring to FIG. 13B, the at least one ranging parameter updated at 1326A may include at least one of an identification of a set of UWB devices (which may include one or more of the third UWB device 1304B and the Nth UWB device 1304N, as well as other UWB devices not depicted in FIGS. 13A and 13B) for which a second set of measurements are to be performed or a set of ranging slot indexes corresponding to the set of UWB devices.

In some aspects, the first network entity may detect, in the ranging slot index, a second RRM from each second network entity of the set of second network entities. The first network entity may perform a second set of measurements based on the first RRM and the second RRM from each second network entity of the set of second network entities. For example, referring to FIG. 13A, after 1312N, the second UWB device 1304A may detect, in the ranging slot index, another RRM from each of the third UWB device 1304B and the Nth UWB device 1304N. For instance, as shown in FIG. 11, at 1114B, the responder 1104A (which is an example of the second UWB device 1304A) may detect, in the ranging slot index, the RRM from the responder 1104B. At 1114N, the responder 1104A may detect, in the ranging slot index, the RRM from the responder 1104N. The second UWB device 1304A may subsequently perform a second set of measurements based on the RRMs received at 1312B and 1312N and the RRMs received at 1114B and 1114N.

In some aspects, the first network entity may receive a second RCM and may initiate a second ranging session based on the second RCM. For example, referring to FIG. 13A, after 1312N, the second UWB device 1304A may receive a second RCM and initiate a second ranging session based on the second RCM. For instance, referring to FIG. 12, the responder 1204A, at 1213, may receive a second RCM from the initiator 1202 and may initiate a second ranging session based on the second RCM.

In some aspects, the first network entity may initiate the second ranging session by transmitting an RIM to a third network entity, receiving a second RRM from the third network entity, and perform a second set of measurements based on the RIM and the second RRM from the third network entity. For example, referring to FIG. 12, after the responder 1204A has been re-configured to be an initiator 1204A′ and the initiator 1202 has been re-configured to be a responder 1202′, the initiator 1204A′, at 1214A, may initiate the second ranging session by transmitting an RIM to the responder 1202′. In response, the initiator 1204A′ may, at 1216, receive an RRM from the responder 1202′ and perform a set of measurements based on the RIM transmitted at 1214A and the RRM received at 1216.

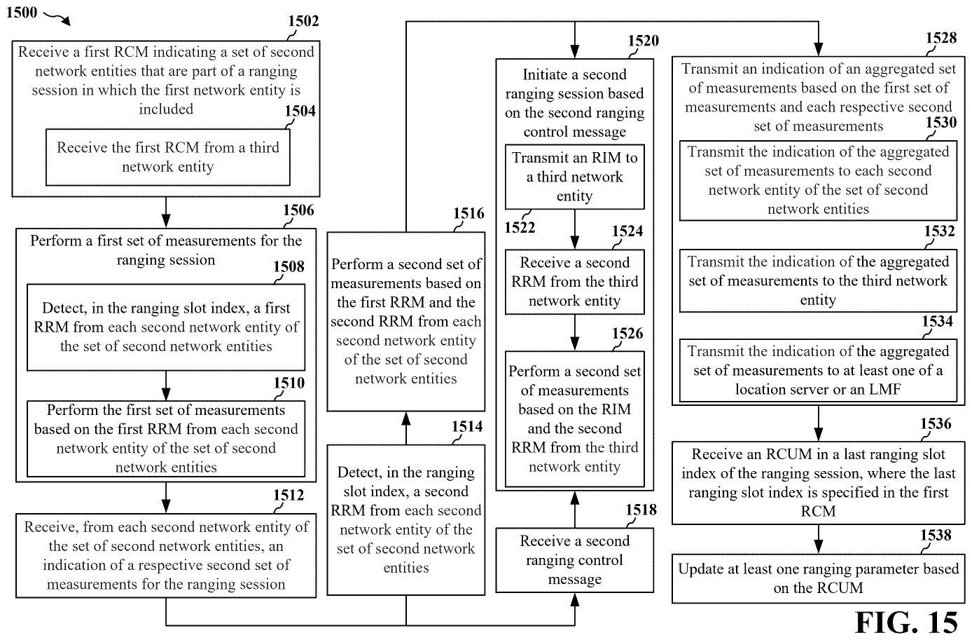

FIG. 15 is a flowchart 1500 illustrating methods of wireless communication at a first network entity in accordance with various aspects of the present disclosure. In some aspects, the first network entity may be the UE 104, the UE 350, the UE 404, the UWB device 604A, the UWB device 604B, the UWB device 604C, the UWB device 702A, the UWB device 702B, the UWB device 712A, the UWB device 712B, the responders 904A-904N, the responders 1004A-1004N, the responders 1104A-1104N, the responders 1204A-1204N, the UWB devices 1304A-1304N or the apparatus 1804 in the hardware implementation of FIG. 18. In the aspects described below, the first network entity may be described with reference to the second UWB device 1304A for the sake of brevity. However, it is noted that the first network entity may be any of UWB devices 1304A-1304N.

At 1502, the first network entity may receive a first RCM indicating a set of second network entities that are part of a ranging session in which the first network entity is included. For example, referring to FIG. 13A, at 1306, the second UWB device 1304A may receive an RCM from the first UWB device 1302. The RCM may indicate that the first UWB device 1302 and/or each of the second UWB device 1304A, the third UWB device 1304B, and/or the Nth UWB device 1304N are part of the ranging session. In an aspect, 1502 may be performed by the cooperative ranging component 198.

In some aspects, the first RCM may further indicate a ranging slot index for the first network entity. For example, referring to FIG. 13A, the RCM received at 1306 may further indicate a ranging slot index for the second UWB device 1304A.

At 1504, the first network entity may receive the first RCM from a third network entity. For example, referring to FIG. 13A, at 1306, the second UWB device 1304A may receive the first RCM from the first UWB device 1302.

At 1506, the first network entity may perform a first set of measurements for the ranging session. For example, referring to FIG. 13A, the second UWB device 1304A may perform a first set of measurements for the ranging session. In an aspect, 1506 may be performed by the cooperative ranging component 198.

In some aspects, as part of 1504, at 1508, the first network entity may perform the first set of measurements for the ranging session by detecting, in the ranging slot index, a first RRM from each second network entity of the set of second network entities. For example, referring to FIG. 13A, at 1312B, the second UWB device 1304A may detect the RRM from the third UWB device 1304B and, at 1312N, may detect the RRM from the Nth UWB device 1304N. In an aspect, 1508 may be performed by the cooperative ranging component 198.

In some aspects, as part of 1504, at 1510, the first network entity may perform the first set of measurements based on the first RRM from each second network entity of the set of second network entities. For example, referring to FIG. 13A, at 1314A, the second UWB device 1304A may perform the first set of measurements for the ranging session based on the RRMs from the third UWB device 1304B and the Nth UWB device 1304N. In an aspect, 1510 may be performed by the cooperative ranging component 198.

At 1512, the first network entity may receive, from each second network entity of the set of second network entities, an indication of a respective second set of measurements for the ranging session. For example, referring to FIG. 13A, at 1312B and 1312N, the second UWB device 1304A may receive, from the third UWB device 1304B and the Nth UWB device 1304N, an indication of a respective second set of measurements for the ranging session. The indication may be the RRMs received at 1312B and 1312N, respectively. For instance, the RRM received at 1312B may include timing information that includes a time between receiving the RIM at the third UWB device 1304B and transmitting the RRM from the third UWB device 1304B, the time and/or angle the RIM was received at the third UWB device 1304B, the time and/or angle the RRM was sent from the third UWB device 1304B, etc. The RRM received at 1312N may include timing information that includes a time between receiving the RIM at the Nth UWB device 1304N and transmitting the RRM from the Nth UWB device 1304N, the time and/or angle the RIM was received at the Nth UWB device 1304N, the time and/or angle the RRM was sent from the Nth UWB device 1304N, etc. In an aspect, 1512 may be performed by the cooperative ranging component 198.

In some aspects, the first network entity may participate in double-sided two-way ranging to mitigate the impact of clock drift between UWB devices. A first approach for double-sided two-way ranging is described below with reference to 1514 and 1516. A second approach for double-sided two-way ranging is described below with reference to 1518, 1520, 1522, 1524, and 1526.

At 1514, the first network entity may detect, in the ranging slot index, a second RRM from each second network entity of the set of second network entities. For example, referring to FIG. 13A, after 1312N, the second UWB device 1304A may detect, in the ranging slot index, another RRM from each of the third UWB device 1304B and the Nth UWB device 1304N. For instance, as shown in FIG. 11, at 1114B, the responder 1104A (which is an example of the second UWB device 1304A) may detect, in the ranging slot index, the RRM from the responder 1104B. At 1114N, the responder 1104A may detect, in the ranging slot index, the RRM from the responder 1104N. In an aspect, 1514 may be performed by the cooperative ranging component 198.

At 1516, the first network entity may perform a second set of measurements based on the first RRM and the second RRM from each second network entity of the set of second network entities. For example, referring to FIG. 13A, after the second UWB device 1304A may perform a second set of measurements based on the RRMs received at 1312B and 1312N and the RRMs received at 1114B and 1114N. In an aspect, 1516 may be performed by the cooperative ranging component 198.

At 1518, first network entity may receive a second RCM. For example, referring to FIG. 13A, after 1312N, the second UWB device 1304A may receive a second RCM. For instance, referring to FIG. 12, the responder 1204A, at 1213, may receive a second RCM from the initiator 1202. In an aspect, 1518 may be performed by the cooperative ranging component 198.

At 1520, first network entity may initiate a second ranging session based on the second RCM. For example, referring to FIG. 13A, after 1312N, the second UWB device 1304A may initiate a second ranging session based on the second RCM. For instance, referring to FIG. 12, the responder 1204A, at 1213, may initiate a second ranging session based on the second RCM. In an aspect, 1520 may be performed by the cooperative ranging component 198.

In some aspects, as part of 1520, at 1522, the first network entity may initiate the second ranging session by transmitting an RIM to a third network entity. For example, referring to FIG. 12, after the responder 1204A has been re-configured to be an initiator 1204A′ and the initiator 1202 has been re-configured to be a responder 1202′, the initiator 1204A′, at 1214A, may initiate the second ranging session by transmitting an RIM to the responder 1202′. In an aspect, 1522 may be performed by the cooperative ranging component 198.

In some aspects, as part of 1520, at 1524, the first network entity may receive a second RRM from the third network entity. For example, referring to FIG. 12, the initiator 1204A′ may, at 1216, receive an RRM from the responder 1202′. In an aspect, 1524 may be performed by the cooperative ranging component 198.

In some aspects, as part of 1520, at 1526, the first network entity may perform a second set of measurements based on the RIM and the second RRM from the third network entity. For example, referring to FIG. 12, the initiator 1204A′ may perform a set of measurements based on the RIM transmitted at 1214A and the RRM received at 1216. In an aspect, 1526 may be performed by the cooperative ranging component 198.

At 1528, the first network entity may transmit an indication of an aggregated set of measurements based on the first set of measurements and each respective set of measurements. For example, referring to FIG. 13B, at 1318A, the second UWB device 1304A may transmit an indication (e.g., an MRM) of the aggregated set of measurements (e.g., the aggregated measurement report generated at 1316A) based on the first set of measurements performed at 1314A and the respective sets of measurements received at 1312B and 1312N. In an aspect, 1528 may be performed by the cooperative ranging component 198.

In some aspects, as part of 1528, at 1530, the first network entity may transmit the indication of the aggregated set of measurements by transmitting the indication of the aggregated set of measurements to each second network entity of the set of second network entities. For example, referring to FIG. 13B, at 1318A, the second UWB device 1304A may transmit the MRM by transmitting the MRM to each of the third UWB device 1304B and the Nth UWB device 1304N. In an aspect, 1530 may be performed by the cooperative ranging component 198.

In some aspects, as part of 1528, at 1532, the first network entity may transmit the indication of the aggregated set of measurements to the third network entity. For example, referring to FIG. 13B, at 1318A, the second UWB device 1304A may transmit the MRM by transmitting the MRM to the first UWB device 1302. In an aspect, 1532 may be performed by the cooperative ranging component 198.

In some aspects, as part of 1528, at 1534, the first network entity may transmit the indication of the aggregated set of measurements by transmitting the indication of the aggregated set of measurements to at least one of a location server or an LMF. For example, referring to FIG. 13B, at 1318A, the second UWB device 1304A may transmit the MRM by transmitting the MRM to the at least one of the location server(s) 168 or the LMF 166. In an aspect, 1534 may be performed by the cooperative ranging component 198.

At 1536, the first network entity may receive an RCUM in a last ranging slot index of the ranging session, where the last ranging slot index is specified in the first RCM. For example, referring to FIG. 13B, at 1324, the second UWB device 1304A may receive an RCUM from the first UWB device 1302 in a last ranging slot index of the ranging session. The last ranging slot index may be specified in the RCM received at 1306. In an aspect, 1536 may be performed by the cooperative ranging component 198.

At 1538, the first network entity may update at least one ranging parameter based on the RCUM. For example, referring to FIG. 13B, at 1326A, the second UWB device 1304A may update at least one ranging parameter based on the RCUM. In an aspect, 1538 may be performed by the cooperative ranging component 198.

In some aspects, the at least one ranging parameter may include at least one of an identification of a set of third network entities for which a second set of measurements are to be performed or a set of ranging slot indexes corresponding to the set of third network entities. For example, referring to FIG. 13B, the at least one ranging parameter updated at 1326A may include at least one of an identification of a set of UWB devices (which may include one or more of the third UWB device 1304B and the Nth UWB device 1304N, as well as other UWB devices not depicted in FIGS. 13A and 13B) for which a second set of measurements are to be performed or a set of ranging slot indexes corresponding to the set of UWB devices.

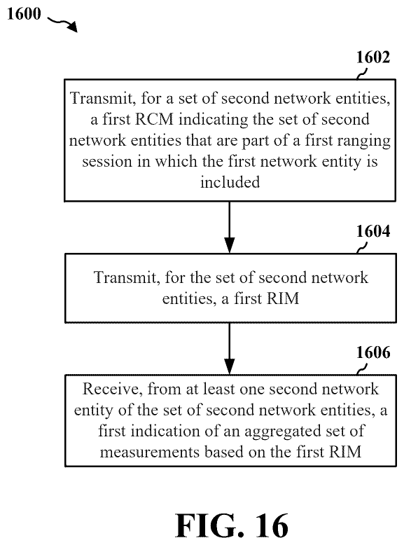

FIG. 16 is a flowchart 1600 illustrating methods of wireless communication at a first network entity in accordance with various aspects of the present disclosure. In some aspects, the first network entity may be the first network entity may be the UE 104, the UE 350, the UE 404, the UWB device 604A, the UWB device 604B, the UWB device 604C, the UWB device 702A, the UWB device 702B, the UWB device 712A, the UWB device 712B, the initiator 902, the initiator 1002, the initiator 1102, the initiator 1202, the first UWB device 1302 or the apparatus 1804 in the hardware implementation of FIG. 18 or the apparatus 1804 in the hardware implementation of FIG. 18.

At 1602, the first network entity may transmit, for a set of second network entities, a first RCM indicating the set of second network entities that are part of a first ranging session in which the first network entity is included. For example, referring to FIG. 13A, at 1306, the first UWB device 1302 may transmit, for the second UWB device 1304A, the third UWB device 1304B, and the Nth UWB device 1304N, an RCM indicating that the second UWB device 1304A, the third UWB device 1304B, and the Nth UWB device 1304N are part of the first ranging session in which the first UWB device 1302 is included. In an aspect, 1602 may be performed by the cooperative ranging component 198.

In some aspects, the first RCM may further indicate a respective ranging slot index for each second network entity of the set of second network entities. For example, referring to FIG. 13A, the RCM transmitted at 1306 may further indicate a respective ranging slot index for each of the second UWB device 1304A, the third UWB device 1304B, and the Nth UWB device 1304N.

At 1604, the first network entity may transmit, for the set of second network entities, a first RIM. For example, referring to FIG. 13A, at 1310, the first UWB device 1302 may transmit, for the second UWB device 1304A, the third UWB device 1304B, and the Nth UWB device 1304N, an RIM. In an aspect, 1604 may be performed by the cooperative ranging component 198.

At 1606, the first network entity may receive, from at least one second network entity of the set of second network entities, a first indication of an aggregated set of measurements based on the first RIM. For example, referring to FIG. 13B, at 1318A, the first UWB device 1302 may receive, from the second UWB device 1304A, an MRM including the aggregated set of measurements based on the RIM transmitted at 1310. At 1318B, the first UWB device 1302 may receive, from the third UWB device 1304B, an MRM including the aggregated set of measurements based on the RIM transmitted at 1310. At 1318N, the first UWB device 1302 may receive, from the Nth UWB device 1304N, an MRM including the aggregated set of measurements based on the RIM transmitted at 1310. In an aspect, 1606 may be performed by the cooperative ranging component 198.

In some aspects, the first network entity may determine a location of the first network entity based on the aggregated set of measurements. For example, referring to FIG. 13B, at 1320, the first UWB device 1302 may determine the location of the first UWB device 1302 based on the MRMs received at 1318A, 1318B and/or 1318N.

In some aspects, the first network entity may transmit, for the set of network entities, an RCUM in a last ranging slot index of the first ranging session. For example, referring to FIG. 13B, at 1324, the first UWB device 1302 may transmit, for the second UWB device 1304A, the third UWB device 1304B, and the Nth UWB device 1304N, an RCUM in the last ranging slot index of the first ranging session.

In some aspects, the RCUM may specify at least one ranging parameter. The at least one ranging parameter may include at least one of an identification of a set of third network entities for which a second set of measurements are to be performed or a set of ranging slot indexes corresponding to the set of third network entities. For example, referring to FIG. 13B, the RCUM transmitted at 1324 may specify at least one ranging parameter. The at least one ranging parameter may include at least one of an identification of a set of network entities for which a second set of measurements are to be performed. The set of network entities may include the second UWB device 1304A, the third UWB device 1304B, the Nth UWB device 1304N, and/or other UWB devices. The at least one ranging parameter may also include a set of ranging slot indexes corresponding to the set of network entities.

In some aspects, the first network entity may determine the set of third network entities based on at least one of a respective signal quality of a respective RRM received from each second network entity of the set of second network entities, a number of the second network entities in the set of second network entities, a respective geometry of each second network entity of the set of second network entities, a respective confidence metric of a position estimate of each second network entity of the set of second network entities, a respective power level of each second network entity of the set of second network entities, a communication protocol supported by each second network entity of the set of second network entities, or a second indication of a particular level of position estimate accuracy supported by one or more second network entities of the set of second network entities. For example, referring to FIG. 13B, at 1322, the first UWB device 1302 may determine another set of network entities for a subsequent ranging based on at least one of a respective signal quality of a respective RRM received from each of the second UWB device 1304A, the third UWB device 1304B, and/or the Nth UWB device 1304N, a number of the UWB devices available (e.g., the second UWB device 1304A, the third UWB device 1304B, the Nth UWB device 1304N and/or other devices that have become in vicinity with the first UWB device 1302) for the subsequent ranging round, a respective geometry of the available UWB devices (e.g., range and/or angle with respect to the first UWB device 1302), a respective confidence metric of a position estimate of each of the second UWB device 1304A, the third UWB device 1304B, and/or the Nth UWB device 1304N (e.g., a level of uncertainty of the each of the second UWB device 1304A, the third UWB device 1304B, and/or the Nth UWB device 1304N with respect to their respective position estimate), a respective power level of each of each of the second UWB device 1304A, the third UWB device 1304B, and/or the Nth UWB device 1304N, a communication protocol supported by each of the second UWB device 1304A, the third UWB device 1304B, and/or the Nth UWB device 1304N, or an indication of a particular level of position estimate accuracy supported by each of the second UWB device 1304A, the third UWB device 1304B, and/or the Nth UWB device 1304N.

In some aspects, the first network entity may provide a second indication of one or more capabilities of the first network entity and receive, based on the one or more capabilities, a third indication that the first network entity is to initiate the first ranging session. For example, referring to FIG. 13A, at 1305A, the first UWB device 1302 may provide a second indication of one or more capabilities of the first UWB device 1302 to the location server 1303 or an LMF thereof. At 1307, the first UWB device 1302 may receive, based on the one or more capabilities, a third indication that the first UWB device 1302 is to initiate the first ranging session.

In some aspects, the first ranging session may be a UWB ranging session, and the capability(ies) may include a first capability that enables the first network entity to determine a location of the first network entity via a communication session other than the UWB ranging session, a second capability based on a level of computational complexity supported by the first network entity, or a third capability based on one or more battery resources supported by the first network entity. For example, referring to FIG. 13A, the first ranging session in which the first UWB device 1302 participates may be a UWB ranging session, and the capability(ies) may include a first capability that enables the first UWB device 1302 to determine its own location via a communication session (e.g., a Wi-Fi-based communication session, a GNSS-based communication session, an NR-based communication session) other than the UWB ranging session, a second capability based on a level of computational complexity supported by the first UWB device 1302, or a third capability based on one or more battery resources supported by the first UWB device 1302.

In some aspects, the first network entity may transmit, for the set of second network entities, a second RCM, where the second RCM is configured for each second network entity of the set of second network entities to initiate a second ranging session. For example, referring to FIG. 13A, after 1312N, the first UWB device 1302 may transmit a second RCM. For instance, referring to FIG. 12, the initiator 1202 at 1213, may transmit a second RCM to the second UWB device 1304A, the third UWB device 1304B, and the Nth UWB device 1304N. The second RCM may be configured for each of the second UWB device 1304A, the third UWB device 1304B, and the Nth UWB device 1304N to initiate a second ranging session.

In some aspects, the first network entity may receive, based on the second RCM, an RIM from each second network entity of the set of second network entities, and transmit an RRM for each second network entity of the set of second network entities. For example, referring to FIG. 12, after the responder 1204A has been re-configured to be an initiator 1204A′ and the initiator 1202 has been re-configured to be a responder 1202′, the responder 1202′ may receive an RIM from each of the initiators 1204A′, 1204B′, and 1204N′ at 1214A, 1214B, and 1214N, respective. In response, at 1216, the responder 1202′ may transmit an RRM to each of the initiators 1204A′, 1204B′, and 1204N′.

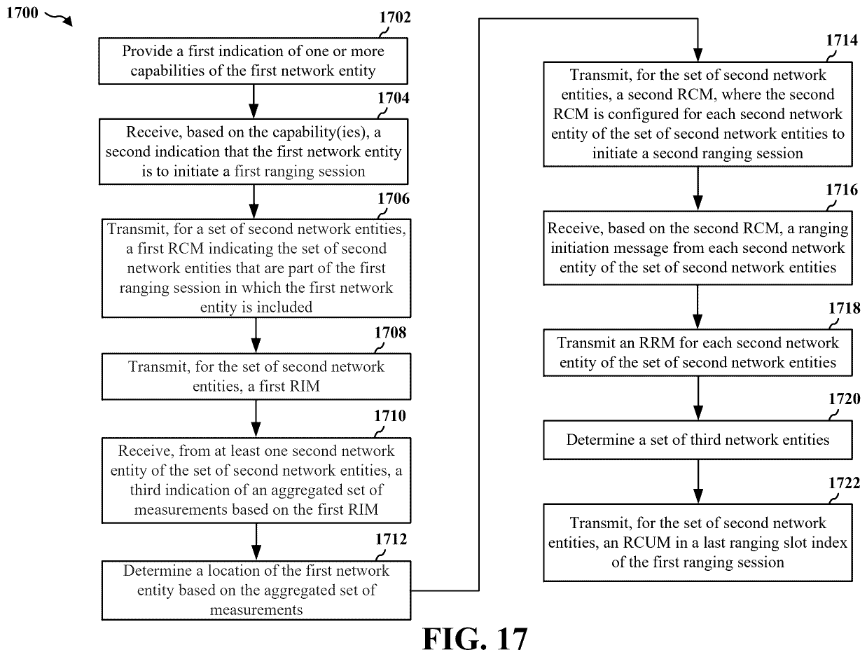

FIG. 17 is a flowchart 1700 illustrating methods of wireless communication at a first network entity in accordance with various aspects of the present disclosure. In some aspects, the first network entity may be the first network entity may be the UE 104, the UE 350, the UE 404, the UWB device 604A, the UWB device 604B, the UWB device 604C, the UWB device 702A, the UWB device 702B, the UWB device 712A, the UWB device 712B, the initiator 902, the initiator 1002, the initiator 1102, the initiator 1202, the first UWB device 1302 or the apparatus 1804 in the hardware implementation of FIG. 18 or the apparatus 1804 in the hardware implementation of FIG. 18.

At 1702, the first network entity may provide a first indication of one or more capabilities of the first network entity. For example, referring to FIG. 13A, at 1305A, the first UWB device 1302 may provide a first indication of one or more capabilities of the first UWB device 1302 to the location server 1303 or an LMF thereof. In an aspect, 1702 may be performed by the cooperative ranging component 198.

At 1704, the first network entity may receive, based on the one or more capabilities, a second indication that the first network entity is to initiate a first ranging session. For example, referring to FIG. 13A, at 1307, the first UWB device 1302 may receive, based on the one or more capabilities, a second indication that the first UWB device 1302 is to initiate the first ranging session. In an aspect, 1704 may be performed by the cooperative ranging component 198.

In some aspects, the first ranging session may be a UWB ranging session, and the capability(ies) may include a first capability that enables the first network entity to determine a location of the first network entity via a communication session other than the UWB ranging session, a second capability based on a level of computational complexity supported by the first network entity, or a third capability based on one or more battery resources supported by the first network entity. For example, referring to FIG. 13A, the first ranging session in which the first UWB device 1302 participates may be a UWB ranging session, and the capability(ies) may include a first capability that enables the first UWB device 1302 to determine its own location via a communication session (e.g., a Wi-Fi-based communication session, a GNSS-based communication session, an NR-based communication session) other than the UWB ranging session, a second capability based on a level of computational complexity supported by the first UWB device 1302, or a third capability based on one or more battery resources supported by the first UWB device 1302.

At 1706, the first network entity may transmit, for a set of second network entities, a first RCM indicating the set of second network entities that are part of the first ranging session in which the first network entity is included. For example, referring to FIG. 13A, at 1306, the first UWB device 1302 may transmit, for the second UWB device 1304A, the third UWB device 1304B, and the Nth UWB device 1304N, an RCM indicating that the second UWB device 1304A, the third UWB device 1304B, and the Nth UWB device 1304N are part of the first ranging session in which the first UWB device 1302 is included. In an aspect, 1706 may be performed by the cooperative ranging component 198.

In some aspects, the first RCM may further indicate a respective ranging slot index for each second network entity of the set of second network entities. For example, referring to FIG. 13A, the RCM transmitted at 1306 may further indicate a respective ranging slot index for each of the second UWB device 1304A, the third UWB device 1304B, and the Nth UWB device 1304N.

At 1708, the first network entity may transmit, for the set of second network entities, a first RIM. For example, referring to FIG. 13A, at 1310, the first UWB device 1302 may transmit, for the second UWB device 1304A, the third UWB device 1304B, and the Nth UWB device 1304N, an RIM. In an aspect, 1708 may be performed by the cooperative ranging component 198.

At 1710, the first network entity may receive, from at least one second network entity of the set of second network entities, a third indication of an aggregated set of measurements based on the first RIM. For example, referring to FIG. 13B, at 1318A, the first UWB device 1302 may receive, from the second UWB device 1304A, an MRM including the aggregated set of measurements based on the RIM transmitted at 1310. At 1318B, the first UWB device 1302 may receive, from the third UWB device 1304B, an MRM including the aggregated set of measurements based on the RIM transmitted at 1310. At 1318N, the first UWB device 1302 may receive, from the Nth UWB device 1304N, an MRM including the aggregated set of measurements based on the RIM transmitted at 1310. In an aspect, 1710 may be performed by the cooperative ranging component 198.

At 1712, the first network entity may determine a location of the first network entity based on the aggregated set of measurements. For example, referring to FIG. 13B, at 1320, the first UWB device 1302 may determine the location of the first UWB device 1302 based on the MRMs received at 1318A, 1318B and/or 1318N. In an aspect, 1712 may be performed by the cooperative ranging component 198.

At 1714, the first network entity may transmit, for the set of second network entities, a second RCM, where the second RCM is configured for each second network entity of the set of second network entities to initiate a second ranging session. For example, referring to FIG. 13A, after 1312N, the first UWB device 1302 may transmit a second RCM. For instance, referring to FIG. 12, the initiator 1202 at 1213, may transmit a second RCM to the second UWB device 1304A, the third UWB device 1304B, and the Nth UWB device 1304N. The second RCM may be configured for each of the second UWB device 1304A, the third UWB device 1304B, and the Nth UWB device 1304N to initiate a second ranging session. In an aspect, 1714 may be performed by the cooperative ranging component 198.

At 1716, the first network entity may receive, based on the second RCM, an RIM from each second network entity of the set of second network entities. For example, referring to FIG. 12, after the responder 1204A has been re-configured to be an initiator 1204A′ and the initiator 1202 has been re-configured to be a responder 1202′, the responder 1202′ may receive an RIM from each of the initiators 1204A′, 1204B′, and 1204N′ at 1214A, 1214B, and 1214N, respective.

At 1718, the first network entity may transmit an RRM for each second network entity of the set of second network entities. For example, referring to FIG. 12, at 1216, the responder 1202′ may transmit an RRM to each of the initiators 1204A′, 1204B′, and 1204N′. In an aspect, 1718 may be performed by the cooperative ranging component 198.

At 1720, the first network entity may determine the set of third network entities based on at least one of a respective signal quality of a respective RRM received from each second network entity of the set of second network entities, a number of the second network entities in the set of second network entities, a respective geometry of each second network entity of the set of second network entities, a respective confidence metric of a position estimate of each second network entity of the set of second network entities, a respective power level of each second network entity of the set of second network entities, a communication protocol supported by each second network entity of the set of second network entities, or a second indication of a particular level of position estimate accuracy supported by one or more second network entities of the set of second network entities. For example, referring to FIG. 13B, at 1322, the first UWB device 1302 may determine another set of network entities for a subsequent ranging based on at least one of a respective signal quality of a respective RRM received from each of the second UWB device 1304A, the third UWB device 1304B, and/or the Nth UWB device 1304N, a number of the UWB devices available (e.g., the second UWB device 1304A, the third UWB device 1304B, the Nth UWB device 1304N and/or other devices that have become in vicinity with the first UWB device 1302) for the subsequent ranging round, a respective geometry of the available UWB devices (e.g., range and/or angle with respect to the first UWB device 1302), a respective confidence metric of a position estimate of each of the second UWB device 1304A, the third UWB device 1304B, and/or the Nth UWB device 1304N (e.g., a level of uncertainty of the each of the second UWB device 1304A, the third UWB device 1304B, and/or the Nth UWB device 1304N with respect to their respective position estimate), a respective power level of each of each of the second UWB device 1304A, the third UWB device 1304B, and/or the Nth UWB device 1304N, a communication protocol supported by each of the second UWB device 1304A, the third UWB device 1304B, and/or the Nth UWB device 1304N, or an indication of a particular level of position estimate accuracy supported by each of the second UWB device 1304A, the third UWB device 1304B, and/or the Nth UWB device 1304N.

At 1722, the first network entity may transmit, for the set of network entities, an RCUM in a last ranging slot index of the first ranging session. For example, referring to FIG. 13B, at 1324, the first UWB device 1302 may transmit, for the second UWB device 1304A, the third UWB device 1304B, and the Nth UWB device 1304N, an RCUM in the last ranging slot index of the first ranging session.

In some aspects, the RCUM may specify at least one ranging parameter. The at least one ranging parameter may include at least one of an identification of a set of third network entities for which a second set of measurements are to be performed or a set of ranging slot indexes corresponding to the set of third network entities. For example, referring to FIG. 13B, the RCUM transmitted at 1324 may specify at least one ranging parameter. The at least one ranging parameter may include at least one of an identification of a set of network entities for which a second set of measurements are to be performed. The set of network entities may include the second UWB device 1304A, the third UWB device 1304B, the Nth UWB device 1304N, and/or other UWB devices. The at least one ranging parameter may also include a set of ranging slot indexes corresponding to the set of network entities.

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include a cellular baseband processor 1824 (also referred to as a modem) coupled to one or more transceivers 1822 (e.g., cellular RF transceiver). The cellular baseband processor 1824 may include on-chip memory 1824′. In some aspects, the apparatus 1804 may further include one or more subscriber identity modules (SIM) cards 1820 and an application processor 1806 coupled to a secure digital (SD) card 1808 and a screen 1810. The application processor 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor 1824 communicates through the transceiver(s) 1822 via one or more antennas 1880 with the UE 104 and/or with an RU associated with a network entity 1802. The cellular baseband processor 1824 and the application processor 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor 1824 and the application processor 1806 are each responsible for general processing, including the execution of software stored on the computer-readable medium/memory. The software, when executed by the cellular baseband processor 1824/application processor 1806, causes the cellular baseband processor 1824/application processor 1806 to perform the various functions described supra. The computer-readable medium/memory may also be used for storing data that is manipulated by the cellular baseband processor 1824/application processor 1806 when executing software. The cellular baseband processor 1824/application processor 1806 may be a component of the UE 350 and may include the memory 360 and/or at least one of the TX processor 368, the RX processor 356, and the controller/processor 359. In one configuration, the apparatus 1804 may be a processor chip (modem and/or application) and include just the cellular baseband processor 1824 and/or the application processor 1806, and in another configuration, the apparatus 1804 may be the entire UE (e.g., see UE 350 of FIG. 3) and include the additional modules of the apparatus 1804.

As discussed supra, the component 198 may be configured to receive a first ranging control message indicating a set of second network entities that are part of a ranging session in which the first network entity is included, to perform a first set of measurements for the ranging session, to receive, from each second network entity of the set of second network entities, an indication of a respective second set of measurements for the ranging session, and to transmit an indication of an aggregated set of measurements based on the first set of measurements and each respective second set of measurements. The component 198 may also be configured to transmit, for a set of second network entities, a first ranging control message indicating the set of second network entities that are part of a first ranging session in which the first network entity is included, to transmit, for the set of second network entities, a first ranging initiation message, and to receive, from at least one second network entity of the set of second network entities, a first indication of an aggregated set of measurements based on the first ranging initiation message. The component 198 may be configured to perform any of the aspects described in connection with the flowcharts in FIGS. 14 and 15 and/or the aspects performed by the second UWB device 1304A in the communication flows in FIGS. 13A and 13B. The component 198 may be within the cellular baseband processor 1824, the application processor 1806, or both the cellular baseband processor 1824 and the application processor 1806. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1804 may include a variety of components configured for various functions. In one configuration, the apparatus 1804, and in particular the cellular baseband processor 1824 and/or the application processor 1806, may include means for receiving a first ranging control message indicating a set of second network entities that are part of a ranging session in which the first network entity is included, means for performing a first set of measurements for the ranging session, means for receiving, from each second network entity of the set of second network entities, an indication of a respective second set of measurements for the ranging session, and means for transmitting an indication of an aggregated set of measurements based on the first set of measurements and each respective second set of measurements. In another configuration, the apparatus 1804, and in particular the cellular baseband processor 1824 and/or the application processor 1806, may include means for transmitting, for a set of second network entities, a first ranging control message indicating the set of second network entities that are part of a first ranging session in which the first network entity is included, means for transmitting, for the set of second network entities, a first ranging initiation message, and means for receiving, from at least one second network entity of the set of second network entities, a first indication of an aggregated set of measurements based on the first ranging initiation message. The means may be the component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

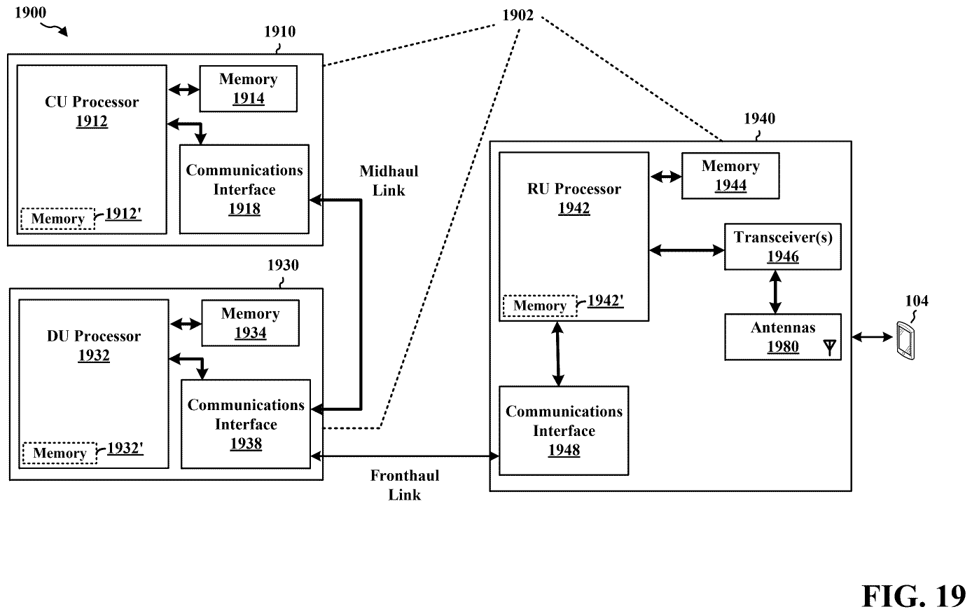

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include a CU processor 1912. The CU processor 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include a DU processor 1932. The DU processor 1932 may include on-chip memory 1932′. In some aspects, the DU 1930 may further include additional memory modules 1934 and a communications interface 1938. The DU 1930 communicates with the RU 1940 through a fronthaul link. The RU 1940 may include an RU processor 1942. The RU processor 1942 may include on-chip memory 1942′. In some aspects, the RU 1940 may further include additional memory modules 1944, one or more transceivers 1946, antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software. Various aspects relate generally to positioning systems. Some aspects more specifically relate to cooperative UWB ranging sessions. In some examples, a UWB initiator may configure a ranging session between the UWB initiator and a plurality of UWB responders. The UWB initiator may transmit a ranging initiation message to each of the UWB responders. In response, each of the UWB responders may transmit a ranging response message to the UWB initiator and to each of the other UWB responders. Each of the UWB responders may perform timing and/or angle measurements based on the ranging initiation message and/or the ranging response messages received thereby. Each of the UWB responders may aggregate the measurements performed thereby, along with the measurements performed by the other UWB responders (which may be received via the ranging response messages). Each of the UWB responders may generate a measurement report that includes the aggregated measurements and may provide the measurement report to the UWB initiator and/or each of the UWB responders. The UWB device (e.g., the UWB initiator or the UWB responders) that receive the measurement reports may determine a range estimate for itself and/or any of the other UWB devices that provided the measurement reports.

In some aspects, one-on-one communication between a UWB initiator and responder may be extended to communication among multiple UWB devices in the same vicinity so that they can exchange measurements to perform cooperative positioning or sensing. In an embodiment, a UWB controller/initiator may generate a ranging control message (RCM), which may include a list of UWB devices in the vicinity and/or ranging slot indexes corresponding to one or more responder transmissions. A responder may listen to channels in the indicated slots and perform measurements. The responder may then provide an aggregate measurement report to the initiator or to all responders. In an aspect, an additional third message may be sent by the transmit side (e.g., by the controller or responder) to remedy clock drift. In one scenario, after a last ranging response message (RRM-N) is sent, all the devices (including the initiator) may transmit an additional third ranging message. In another scenario, after the RRM-N is sent, the initiator may transmit the additional ranging message and the controller schedules one-way ranging sessions originating from all other devices. In an embodiment, a ranging control update message may be transmitted by the controller during the last slot of a ranging round to update ranging parameters for the next ranging round, where the parameters may include—for each responder a subset of vicinity devices whose measurements are to be recorded and their corresponding set of slot indexes. In an aspect, the subset of vicinity devices for a responder may be determined by the controller or a remote server based on certain criteria, such as the quality of received signals, the number of neighboring devices and nodes, the geometry of the vicinity devices (and/or their neighboring devices), the connectivity of the vicinity devices (and/or their neighboring devices) to another technology, a requirement of the vicinity devices (and/or their neighboring devices) for higher position estimate accuracy.

Particular aspects of the subject matter described in this disclosure can be implemented to realize one or more of the following potential advantages. In some examples, by cooperatively performing and sharing measurements between a plurality of UWB devices, the time of arrival estimation quality is improved, which in turn, enables a more accurate range estimate for a particular device, as there are additional points of reference with respect to the device for which the range estimate is determined.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a first network entity, comprising: receiving a first ranging control message indicating a set of second network entities that are part of a ranging session in which the first network entity is included; performing a first set of measurements for the ranging session; receiving, from each second network entity of the set of second network entities, an indication of a respective second set of measurements for the ranging session; and transmit an indication of an aggregated set of measurements based on the first set of measurements and each respective second set of measurements.
Aspect 2 is the method of aspect 1, wherein the first ranging control message further indicates a ranging slot index for the first network entity.
Aspect 3 is the method of aspect 2, wherein performing the first set of measurements for the ranging session comprises: detecting, in the ranging slot index, a first ranging response message from each second network entity of the set of second network entities; and performing the first set of measurements based on the first ranging response message from each second network entity of the set of second network entities.
Aspect 4 is the method of aspect 3, further comprising: detecting, in the ranging slot index, a second ranging response message from each second network entity of the set of second network entities; and performing a second set of measurements based on the first ranging response message and the second ranging response message from each second network entity of the set of second network entities.
Aspect 5 is the method of aspect 3, further comprising: receiving a second ranging control message; and initiating a second ranging session based on the second ranging control message.
Aspect 6 is the method of aspect 5, wherein initiating the second ranging session comprises: transmitting a ranging initiation message to a third network entity; receiving a ranging response message from the third network entity; and performing a second set of measurements based on the ranging initiation message and the ranging response message from the third network entity.
Aspect 7 is the method of any of aspects 1 to 6, wherein transmitting the indication of the aggregated set of measurements comprises transmitting the indication of the aggregated set of measurements to each second network entity of the set of second network entities.
Aspect 8 is the method of any of aspects 1 to 6, wherein receiving the first ranging control message comprises receiving the first ranging control message from a third network entity, and wherein transmitting the indication of the aggregated set of measurements comprises transmitting the indication of the aggregated set of measurements to the third network entity.
Aspect 9 is the method of any of aspects 1 to 6, wherein transmitting the indication of the aggregated set of measurements comprises transmitting the indication of the aggregated set of measurements to at least one of a location server or a location management function (LMF).
Aspect 10 is the method of any of aspects 1 to 9, further comprising: receiving a ranging control update message in a last ranging slot index of the ranging session, wherein the last ranging slot index is specified in the first ranging control message; and updating at least one ranging parameter based on the ranging control update message.
Aspect 11 is the method of aspect 10, wherein the at least one ranging parameter comprises at least one of: an identification of a set of third network entities for which a second set of measurements are to be performed; or a set of ranging slot indexes corresponding to the set of third network entities.
Aspect 12 is a method of wireless communication at a first network entity, comprising transmitting, for a set of second network entities, a first ranging control message indicating the set of second network entities that are part of a first ranging session in which the first network entity is included; transmitting, for the set of second network entities, a first ranging initiation message; and receiving, from at least one second network entity of the set of second network entities, a first indication of an aggregated set of measurements based on the first ranging initiation message.
Aspect 13 is the method of aspect 12, further comprising: determining a location of the first network entity based on the aggregated set of measurements.
Aspect 14 is the method of any of aspects 12 and 13, wherein the ranging control message further indicates a respective ranging slot index for each second network entity of the set of second network entities.
Aspect 15 is the method of any of aspects 12 to 14, further comprising: transmitting, for the set of second network entities, a second ranging control message, wherein the second ranging control message is configured for each second network entity of the set of second network entities to initiate a second ranging session.
Aspect 16 is the method of aspect 15, further comprising: receiving, based on the second ranging control message, a ranging initiation message from each second network entity of the set of second network entities; and transmitting a ranging response message for each second network entity of the set of second network entities.
Aspect 17 is the method of any of aspects 12 to 16, further comprising: transmitting, for the set of second network entities, a ranging control update message in a last ranging slot index of the first ranging session.
Aspect 18 is the method of aspect 17, wherein the ranging control update message specifies at least one ranging parameter, and wherein the at least one ranging parameter comprises at least one of: an identification of a set of third network entities for which a second set of measurements are to be performed; or a set of ranging slot indexes corresponding to the set of third network entities.
Aspect 19 is the method of aspect 18, further comprising: determining the set of third network entities based on at least one of: a respective signal quality of a respective ranging response message received from each second network entity of the set of second network entities; a number of the second network entities in the set of second network entities; a respective geometry of each second network entity of the set of second network entities; a respective confidence metric of a position estimate of each second network entity of the set of second network entities; a respective power level of each second network entity of the set of second network entities; a communication protocol supported by each second network entity of the set of second network entities; or a second indication of a particular level of position estimate accuracy supported by one or more second network entities of the set of second network entities.
Aspect 20 is the method of any of aspects 12 to 19, further comprising: providing a second indication of one or more capabilities of the first network entity; and receiving, based on the one or more capabilities, a third indication that the first network entity is to initiate the first ranging session.
Aspect 21 is the method of aspect 20, wherein the first ranging session is an ultra-wideband (UWB) ranging session, and wherein the one or more capabilities comprise a first capability that enables the first network entity to determine a location of the first network entity via a communication session other than the UWB ranging session, a second capability based on a level of computational complexity supported by the first network entity, or a third capability based on one or more battery resources supported by the first network entity.
Aspect 22 is an apparatus for wireless communication at a first network entity. The apparatus comprises memory; and at least one processor coupled to the memory and, based at least in part on information stored in the memory, the at least one processor is configured to implement any of aspects 1 to 11.
Aspect 23 is the apparatus of aspect 22, further comprising at least one of a transceiver or an antenna coupled to the at least one processor.
Aspect 24 is an apparatus for wireless communication at a first network entity. The apparatus comprises memory; and at least one processor coupled to the memory and, based at least in part on information stored in the memory, the at least one processor is configured to implement any of aspects 12 to 21.
Aspect 25 is the apparatus of aspect 24, further comprising at least one of a transceiver or an antenna coupled to the at least one processor.
Aspect 26 is an apparatus for wireless communication including means for implementing any of aspects 1 to 11.
Aspect 27 is an apparatus for wireless communication including means for implementing any of aspects 12 to 21.
Aspect 28 is a computer-readable medium (e.g., a non-transitory computer-readable medium) storing computer executable code, wherein the code when executed by a processor causes the processor to implement any of aspects 1 to 11.
Aspect 29 is a computer-readable medium (e.g., a non-transitory computer-readable medium) storing computer executable code, wherein the code when executed by a processor causes the processor to implement any of aspects 12 to 21.

1. An apparatus for wireless communications at a first network entity, comprising:
a memory; and
at least one processor coupled to the memory and, based at least in part on information stored in the memory, the at least one processor is configured to:
receive a first ranging control message indicating a set of second network entities that are part of a ranging session in which the first network entity is included;
perform a first set of measurements for the ranging session; receive, from each second network entity of the set of second network entities, an indication of a respective second set of measurements for the ranging session; and
transmit an indication of an aggregated set of measurements based on the first set of measurements and each respective second set of measurements.

2. The apparatus of claim 1, wherein the first ranging control message further indicates a ranging slot index for the first network entity.

3. The apparatus of claim 2, wherein, to perform the first set of measurements for the ranging session, the at least one processor is configured to:
detect, in the ranging slot index, a first ranging response message from each second network entity of the set of second network entities; and
perform the first set of measurements based on the first ranging response message from each second network entity of the set of second network entities.

4. The apparatus of claim 3, wherein the at least one processor is further configured to:
detect, in the ranging slot index, a second ranging response message from each second network entity of the set of second network entities; and
perform a second set of measurements based on the first ranging response message and the second ranging response message from each second network entity of the set of second network entities.

5. The apparatus of claim 3, wherein the at least one processor is further configured to:
receive a second ranging control message; and
initiate a second ranging session based on the second ranging control message.

6. The apparatus of claim 5, wherein, to initiate the second ranging session, the at least one processor is configured to:
transmit a ranging initiation message to a third network entity;
receive a ranging response message from the third network entity; and perform a second set of measurements based on the ranging initiation message and the ranging response message from the third network entity.

7. The apparatus of claim 1, wherein, to transmit the indication of the aggregated set of measurements, the at least one processor is configured to:
transmit the indication of the aggregated set of measurements to each second network entity of the set of second network entities.

8. The apparatus of claim 1, wherein, to receive the first ranging control message, the at least one processor is configured to:
receive the first ranging control message from a third network entity, and wherein, to transmit the indication of the aggregated set of measurements, the at least one processor is configured to:
transmit the indication of the aggregated set of measurements to the third network entity.

9. The apparatus of claim 1, wherein, to transmit the indication of the aggregated set of measurements, the at least one processor is configured to:
transmit the indication of the aggregated set of measurements to at least one of a location server or a location management function (LMF).

10. The apparatus of claim 1, wherein the at least one processor is further configured to:
receive a ranging control update message in a last ranging slot index of the ranging session, wherein the last ranging slot index is specified in the first ranging control message; and
update at least one ranging parameter based on the ranging control update message.

11. The apparatus of claim 10, wherein the at least one ranging parameter comprises at least one of:
an identification of a set of third network entities for which a second set of measurements are to be performed; or
a set of ranging slot indexes corresponding to the set of third network entities.

12. An apparatus for wireless communications at a first network entity, comprising:
a memory; and
at least one processor coupled to the memory and, based at least in part on information stored in the memory, the at least one processor is configured to:
transmit, for a set of second network entities, a first ranging control message indicating the set of second network entities that are part of a first ranging session in which the first network entity is included;
transmit, for the set of second network entities, a first ranging initiation message; and
receive, from at least one second network entity of the set of second network entities, a first indication of an aggregated set of measurements based on the first ranging initiation message.

13. The apparatus of claim 12, wherein the at least one processor is further configured to:
determine a location of the first network entity based on the aggregated set of measurements.

14. The apparatus of claim 12, wherein the first ranging control message further indicates a respective ranging slot index for each second network entity of the set of second network entities.

15. The apparatus of claim 12, wherein the at least one processor is further configured to:
transmit, for the set of second network entities, a second ranging control message, wherein the second ranging control message is configured for each second network entity of the set of second network entities to initiate a second ranging session.

16. The apparatus of claim 15, wherein the at least one processor is further configured to:
receive, based on the second ranging control message, a ranging initiation message from each second network entity of the set of second network entities; and transmit a ranging response message for each second network entity of the set of second network entities.

17. The apparatus of claim 12, wherein the at least one processor is further configured to:
transmit, for the set of second network entities, a ranging control update message in a last ranging slot index of the first ranging session.

18. The apparatus of claim 17, wherein the ranging control update message specifies at least one ranging parameter, and wherein the at least one ranging parameter comprises at least one of:
an identification of a set of third network entities for which a second set of measurements are to be performed; or
a set of ranging slot indexes corresponding to the set of third network entities.

19. The apparatus of claim 18, wherein the at least one processor is further configured to:
determine the set of third network entities based on at least one of:
a respective signal quality of a respective ranging response message received from each second network entity of the set of second network entities; a number of the second network entities in the set of second network entities;
a respective geometry of each second network entity of the set of second network entities;
a respective confidence metric of a position estimate of each second network entity of the set of second network entities;
a respective power level of each second network entity of the set of second network entities;
a communication protocol supported by each second network entity of the set of second network entities; or
a second indication of a particular level of position estimate accuracy supported by one or more second network entities of the set of second network entities.

20. The apparatus of claim 12, wherein the at least one processor is further configured to:
provide a second indication of one or more capabilities of the first network entity; and
receive, based on the one or more capabilities, a third indication that the first network entity is to initiate the first ranging session.

21-30. (canceled)
